(19) United States
(12) Patent Application Publication
(10) Pub. No.: US 2024/0173727 A1
(43) Pub. Date: May 30, 2024

(54) FLUID DISPENSING SYSTEM AND MANIFOLD ASSEMBLY FOR CLEANING VEHICLE SURFACES

(71) Applicant: Ficosa Automotive S.L.U., Barcelona (ES)

(72) Inventor: Olallo Alcaide Hernández, Viladecavalls (ES)

(21) Appl. No.: 18/435,075

(22) Filed: Feb. 7, 2024

Related U.S. Application Data
(63) Continuation-in-part of application No. 17/416,288, filed on Jun. 18, 2021, now Pat. No. 11,926,290.

(30) Foreign Application Priority Data
Dec. 18, 2018 (EP) 18382943.1

(51) Int. Cl. B05B 1/30; B05B 12/00; B05B 15/18; B05B 15/555; B05B 15/65

(52) U.S. Cl. CPC B05B 1/3013; B05B 12/004; B05B 15/555; B05B 15/65; B05B 15/18

(57) ABSTRACT

A fluid dispensing system includes one or more pumps, the one or more pumps include an inlet connected to a source of fluid and an outlet. Fluid dispensers are fluidically connected to the one or more pumps. The fluid dispensers direct fluid towards a surface. A control circuit is operatively connected to each of the one or more pumps. The control circuit activates the one or more pumps to wash the surface. A manifold includes one or more fluid inlets connected to each of the one or more pumps and a plurality of fluid outlets each connected to the fluid dispensers. At least one check valve is arranged at one of a first position at the outlet of the corresponding one or more pumps and at a second position between the one or more pumps and the manifold and at a third position integrated into the manifold.

### CROSS-REFERENCE TO RELATED APPLICATIONS

This application is a continuation-in-part of U.S. application Ser. No. 17/416,288, filed Jun. 18, 2021, which is a National Stage Application of PCT/EP2019/085767, filed Dec. 17, 2019, which claims priority European Application No. 18382943.1, filed Dec. 18, 2018, the contents of which are hereby incorporated by reference in its entirety.

### TECHNICAL FIELD

The present disclosure relates to fluid dispensing systems and, more particularly, to a fluid dispensing system for cleaning vehicle surfaces and a manifold for a vehicle fluid dispensing system.

### BACKGROUND

In known fluid dispensing systems, fluid is pumped from tanks or reservoirs by suitable pumps and discharged out towards a target object through nozzles that are connected to the pumps.

U.S. Pat. No. 5,190,442 discloses an electronic pump control system for ensuring that pumps run for the same percentage of time. The system comprises a container for liquid, sensing means for determining the level of liquid in the container, a number of pumps each having an inlet communicating with the container and an outlet communicating with a common conduit for liquid being pumped out of the container, and a pump controller with processor means for controlling the operation of the pumps and for starting and stopping individual pumps.

A further pump control system is disclosed in GB2537461. It comprises a reservoir, a pump, a reservoir level sensor, a current monitor to monitor the current drawn by the pump, and a controller to generate head data from level data and determining a difference between current drawn in different periods, providing a pump performance indicator showing the condition of the pump. A performance indicator is calculated for each period, allowing an operator to predict when maintenance is required.

US20030075207 A1 discloses a cleaning liquid supply system for a vehicle that comprises a tank for storing cleaning liquid, a headlamp nozzle which receives the cleaning liquid from the tank and discharges the cleaning liquid to a corresponding headlamp of the vehicle, and a pump apparatus which is connected to the tank and the headlamp nozzle and pumps the cleaning liquid supplied from the tank to the headlamp nozzle.

It has been found that in known vehicle fluid dispensing systems for washing two or more target objects do not properly control the flow rate of cleaning fluid to be delivered to one or more target objects when a command for washing is received. In particular, the present fluid dispensing system may provide an advantage of delivering cleaning fluid to a first target surface to be washed while preventing cleaning fluid delivery to a second target surface according to a first command of washing. Further, according to a second command of washing, the fluid dispensing system of the present invention allows delivering cleaning fluid to the second target surface while selectively preventing cleaning fluid delivery to the first target surface.

Further, in known fluid dispensing systems for washing devices it has been found that since fluid dispensers are connected to corresponding pumps and pumps are all operated in the same way, wear is always produced in the same pumps in the fluid dispensing system. This in practice involves drawbacks since pumps wear in different ways and therefore some pumps could be required to be serviced or repaired while others still work well.

Also, it may be a purpose of the present invention to reduce complexity and number of components of fluid dispensing systems, for example, by reducing the number of pumps without reducing the number of a plurality of target surfaces to be cleaned.

### SUMMARY

A fluid dispensing system and a washing method (i.e., cleaning method) are herein disclosed with which the above problem is solved and with which many significant advantages are obtained as it will be explained in the following. Further, a manifold for a vehicle fluid dispensing system is provided with a check valve therein.

Within the meaning of the present disclosure, target object refers herein to a sensor, an optical surface of a sensor for example fitted in a motor vehicle, or any other kind of surfaces in motor vehicle parts such as windshields, sensor protectors, headlamps, etc. and, in general, parts required to be washed. Different target objects may have different cleaning requirements and thus different amounts of fluid, delivered at different pressures, etc. For example, having the same soiling status or dirtiness condition, a Lidar may require a greater flow rate than a camera.

An object of the present application is to provide a fluid dispensing system that may comprise:
one or more pumps configured to be supplied with fluid from a source of fluid;
a plurality of fluid dispensers each configured to receive fluid from at least one or more pumps and dispensing it towards at least one target surface; and
a control unit (i.e. control circuit) configured to operate at least one selected pump for supplying fluid to at least one target surface according to a received command of washing.

The washing command may be output either by the control unit or at the request of a user. Further, the control unit may be further configured to receive or determine required fluid demands of the target surface to be delivered towards the target surface. Further, the control unit may be configured to operate one or more pumps depending on the fluid demands. That is, the control circuit is configured to operate which pump or pumps has/have to be operated depending on the fluid demands.

Preferably, the present system further may include a manifold comprising one or more fluid inlets into which the fluid is gathered from the one or more pumps, and a number of fluid outlets, e.g., two or more fluid outlets, from which the fluid is distributed towards the target surface. This is, the manifold may comprise a first fluid inlet manifold, a first fluid outlet manifold and a second fluid outlet manifold.

Preferably, the present system further may include at least one control valve, e.g., an electro valve, arranged between the manifold and at least one of the plurality of fluid dispensers, including inside at least one fluid dispenser or in the manifold (e.g. being part of or attached to the manifold). Said at least one control valve being actuated by the control unit for allowing or preventing at least one of the M fluid dispensers to dispense fluid towards at least a target surface.

It is preferred that the plurality of M fluid dispensers may comprise a first fluid dispenser and a second fluid dispenser, and the at least one control valve may comprise a first control valve and a second control valve, wherein the control unit may be further configured to operate:
the first control valve for allowing the first fluid dispenser to dispense fluid towards at least a first target surface; and/or
the second control valve for preventing the second fluid dispenser to dispense fluid towards at least a second target surface.

The at least one control valve may be normally closed. That is, one or more control valves may prevent fluid from flowing through when electric power is not supplied, or any power/data signal is not received. Instead, the one or more control valves may allow fluid to flow through when electric power is supplied, or any power/data signal is received (i.e. generated or sent by the control unit).

More preferably, the first fluid dispenser may be configured to receive fluid from at least the first outlet manifold and dispensing it towards at least the first target surface when the first control valve is actuated by the control unit, wherein the second fluid dispenser is configured to receive fluid from at least the second outlet manifold and dispensing it towards at least the second target surface when the second control valve is actuated by the control unit. Further, the first control valve may be arranged between the first outlet manifold and a first fluid dispenser outlet, wherein the second control valve may be arranged between the second outlet manifold and a second fluid dispenser outlet. The first and the second fluid dispenser outlets may be the outlets of the fluid dispensers which are configured to dispense fluid towards the first and second target surfaces.

Preferably, the present system may further include at least one check valve arranged between the one or more pumps and the manifold (e.g., a first or second fluid outlet manifold), including at the pump or in the manifold, for preventing backflow towards the one or more pumps. In fact, the at least one check valve is configured to prevent backflow from the manifold to at least one or more pumps. The at least one check valve may be defined as one way valve. The at least one check valve may be arranged at least one of a first position, a second position and a third position. The first position is at the outlet of the corresponding one or more pumps. The second position is between the one or more pumps and the manifold. The third position is integrated into the manifold (e.g., within a manifold chamber as explained further below). That is, the at least one check valve may be arranged between the two or more pumps and the manifold, including at the pump or in the manifold, for preventing backflow towards the two or more pumps.

A problem associated with fluid dispensing systems is that the cleaning of a sensor (e.g., camera) or any target surface to be cleaned is usually 1 to 3 seconds. Such a short time may not be enough for the pump to provide full power. An important advantage of the present dispensing system is to have a certain pressure of the fluid in the manifold. For example, said certain pressure may be obtained therebetween the check valve and the control valves when provided.

Once the one or more pumps is/are activated and the control valve(s) is/are open, the fluid ends up being discharged through one or more fluid dispenser(s). Instead, once the control valve is closed, there remain advantageously fluid in the manifold (e.g. between the check valve and the control valve). The check valve prevents fluid to get out the manifold (i.e., to flow back to the fluid source). In this way, when the system is not discharging fluid, the system (at least the manifold) may be advantageously pressurized (e.g., above 1.5 atm in absolute pressure) or there may be liquid trapped in the manifold. That is, when all the control valves are closed, a permanent pressure between the one or more check valve(s) and (the two or more) control valves may be advantageously achieved. Permanent pressure is understood as a pressure that will be substantially maintained in time when the control valve is closed (i.e. until a control valve is opened). Said permanent pressure may be above 0.5 bar in relative pressure, for example, between 0.5 bar to 10 bar depending on system requirements.

When one or more control valves are open, the system (e.g., the manifold) already has certain pressure (or at least certain cleaning liquid is contained in the manifold) so that the fluid discharge through the nozzle is more effective (i.e. higher pressure) particularly in the instant of time right after activating the pump.

Due to this permanent pressure, the present fluid dispensing system is improved in that:
system reaction time is decreased. The time from the cleaning command (e.g., when the control valve(s) is/are open) to fluid ejection is decreased; and
higher fluid pressure is achieved. Fluid pressure at the fluid dispenser may be higher than without pre-pressurizing the manifold. Or, at least, the maximum pressure at the fluid dispenser is obtained earlier.

Thus, when the manifold is not pressurized in advance (i.e., no permanent pressure is obtained before the cleaning command), the time for having fluid pressure in the fluid dispenser inlet takes disadvantageously certain time. Instead, an option according to the present invention is provide a predefined (pre-determined) fluid (either gas or liquid) between the check valve and the control valve(s). In this way, it is possible to have a pressurized manifold in advance. As a consequence, the time for having fluid pressure in the fluid dispenser inlet is advantageously reduced. Furthermore, the pressure in the fluid dispenser inlet is higher when the system (e.g., manifold) is pre-pressurized than the pressure in the fluid dispenser inlet without being pre-pressurized in the same instant of time.

Furthermore, it is preferred that the manifold includes a manifold chamber defined between the one or more (fluid) inlets and the plurality of (fluid) outlets, the at least one check valve being arranged in the manifold chamber. The at least one check valve may include a check valve assembly that includes a frame and at least one movable portion being pivotally connected to the frame.

It is preferred that the manifold may comprise a housing that includes, in turn, an inner surface configured to receive at least a portion of the check valve such that, in use, the manifold and the check-valve are attached to each other. Preferably, the check valve may comprise the at least one movable portion, wherein fluid pressure causes the movable portion to turn on an axis when the fluid flows through. Said axis may be perpendicular to the flow of fluid when moving the movable portion. That is, the movable portion is pivoting. More preferably, the movable portion may be a deformable portion which may comprise a flexible membrane. Indeed, the movable portion may be formed from a resilient material. The check valve may be configured to have an open position and a close position, wherein the close position prevents backflow towards the one or more pumps, preferably towards the two or more pumps. In the open position, the fluid in the manifold causes the movable portion to turn on an axis such that the manifold is configured to distribute the fluid towards at least one fluid dispenser. It may be further preferred that the manifold housing comprises a second inner surface configured to abut the check valve in the open position so as to restrict the movement of the movable portion. Preferably, the movable portion in the open position has an angle of between 3° and 80°. In another example, the open position has an angle of between 5°-60° with respect to the closed position. More preferably, an angle of between 10°-45°, and even more preferably, and angle of between 15°-30°. It may be possible the present fluid dispensing system may further include a plurality of pumps (i.e., two or more pumps), wherein the manifold includes a plurality of fluid inlets (i.e. two or more fluid inlets), and wherein the at least one check valve includes a plurality of movable portions. In this way, the check-valve may comprise a frame and two or more movable portions, wherein the frame is attached to the inner surface of the manifold. It is preferred that each of the plurality of movable portions is integrally formed with the frame.

The manifold may include a housing having an inlet housing part supporting one or more fluid inlets (e.g., the plurality of fluid inlets) and an outlet housing part supporting the plurality of fluid outlets. The frame may be mounted between the inlet housing part and the outlet housing part. Preferably, an inner surface of the inlet housing part may abut a first surface of the frame, wherein an inner surface of the outlet housing part may abut a second surface of the frame. The first and second surface of the frame may be opposed to each other.

It is preferred that the manifold further includes an inner surface defining a travel limiter. More preferably, the outlet housing part includes the inner surface defining the travel limiter. In use, the travel limiter may be adapted for abutting the at least one movable portion (e.g., the plurality of movable portions) when moving from the closed position to the open position.

The manifold, as stated below, may have different geometries and/or architectures as long as it is provided with a first fluid inlet, a first fluid outlet and a second fluid outlet. Therefore, the manifold may comprise one or more housing parts as longs as the fluid may enter the manifold and be distributed to different fluid dispensers as required. It may be possible the inlets and outlets of the manifold converge within a single manifold chamber. Optionally, the single chamber may be a piping provided with one or more inlets and two or more outlets. It may be preferred that the present manifold may comprise a first manifold chamber and one or more pipes fluidly connected to one or more outlets of the first manifold chamber. Further, the manifold may further comprise one or more pipes fluidly connected to one or more inlets of the first manifold chamber. It may be preferred that the fluid pressure in the first manifold chamber and in the one or more pipes are substantially the same or similar.

It is preferred that the present fluid dispensing system may further comprise a (first) ring circuit connected between at least two of the plurality of fluid outlets (of the manifold). The (first) ring circuit supports one or more of the plurality of fluid dispensers. The manifold may be a one-single device. Preferably, the first ring circuit may be provided with a first and second inlets into which the fluid is gathered from the one or more pumps, and a first and second outlets from which the fluid is distributed towards the target surface. Further, at least a first and second fluid dispensers are fluidly connected to the first ring circuit being fluidly arranged between the first and second inlets. It should be noted that the above-mentioned first manifold chamber is optional.

More preferably, if the first manifold chamber is provided, the manifold may comprise thus said first manifold chamber and the first ring circuit. The first manifold chamber may be provided with one or more inlets manifold chamber into which the fluid is gathered from the one or more pumps, and a first outlet manifold chamber and a second outlet manifold chamber from which the fluid is distributed towards the target surface. Further, the first ring circuit may be fluidly connected to the first outlet manifold chamber and to the second outlet manifold chamber, wherein at least one of the M fluid dispensers may be fluidly connected to the first ring circuit being fluidly arranged between the first and second outlet manifold chamber.

It is preferred that the fluid is a cleaning fluid such as cleaning liquid or air. The control unit may be an electronic control unit (ECU) also refer herein as a control circuit. Further, the above-mentioned control valves may be electro-valves.

For reasons of clarity, the different component parts of the present fluid dispensing system and manifold, and the steps of the washing method will be described separately in the following sections.

The present fluid dispensing system may comprise at least one fluid source, such as a tank or reservoir, suitable for containing fluid, e.g., cleaning fluid, such as washing liquid or air. As used herein, at least one fluid source means that one or more fluid sources may be provided having the same or different capacities. One preferred example of fluid is a suitable washing liquid.

As stated above, at least one pump is provided. A number of pumps may also be provided. Each pump is configured to be supplied with said fluid from the one or more fluid sources. The pumps may be, for example, a fluid pump or an air compressor or any device configured to supply fluid (either washing liquid or gas) with a certain pressure. The pressure may be 1 to 15 bar. Pumps employed in the present system may be, for example, DC powered 2-3 bar radial turbo centrifugal pumps capable of supplying a flow rate of the order of 5000 cm³/min, normally 2000 to 3000 cm³/min. Other types of pumps, such as variable output pumps, are of course possible if they are capable of being supplied with fluid from the one or more fluid sources. Pumps used for the purposes of the present disclosure such as for automotive applications may have for example an operating voltage of the order of 9.5-11V. Different orders of magnitude for pump voltages are also possible depending on requirements and applications. Electrical power may be supplied to the pumps by a power supply such as a battery that may be built-in the control unit or it may be a separate power supply. The control unit can communicate with the power supply for supplying the required electrical power to the pump which is controlled by the control unit.

In one example, when two or more pumps are provided, the pumps may be arranged at different heights (or may take fluid from different heights) for allowing a volume of cleaning fluid present in at least one fluid source when provided to be accurately determined by the control unit. For example, the two or more pumps may be arranged in the fluid source and associated with corresponding outlets. As used herein, the expression “height” throughout the present disclosure refers to a distance from a given first point, such as the ground, to a second, different point that belongs to a pump itself or to a portion thereof such as for example a pump body, or a connection between the fluid source and the pump (a tank fluid outlet, for example), or any other element in the pump. Thus, although in the most usual scenario a number of pumps are provided at different heights in the fluid source, the expression “pumps arranged at different heights” encompasses also a number of pumps arranged at the same height but connected to the fluid source at points located at different heights.

More preferably, the control unit may determine the volume of cleaning fluid based on at least one of the following operating parameters: voltage, current, washing fluid flow rate, and current frequency.

The at least one pump allows a volume of fluid present in the fluid source to be accurately determined. Determining a volume of fluid in the fluid source may be carried out from a condition when the pump or the pumps arranged at a given height stop drawing fluid from the fluid source since no fluid is present. This may be carried out from a condition when pumps at a given height stop drawing fluid from the fluid source since no fluid is present. This can be carried out by a control unit which will be described further below, adapted to be fed by operating parameters of said pumps. As a result, detection of fluid level at discreet positions may be possible. With said pump arrangement when a given pump is determined not to work properly, another pump located at a lower height may be operated.

In further examples, when two or more pumps are provided, at least some of the pumps may be arranged in parallel to each other. Pumps are preferred to be arranged in parallel to each other when higher flow rate is required to be supplied than in the case if one pump is provided. Otherwise, pumps are preferred to be arranged in series to each other when higher pressure fluid is required to be supplied than in the case if one pump is provided.

Still in further examples, when at least two or more pumps are provided, at least one of them may be arranged in series to each other. Other pump arrangements and combinations thereof are of course possible.

In addition, when two or more pumps are provided, at least one of them may have different capacity from the others although it is preferred that pumps in the present fluid dispensing system all have a single characteristic curve or power. However, there may be cases where pump power may be adjusted over time by the control unit for the same pump. For example, the control unit may operate one or more pumps at a specified time providing a pressure of 1.5 bars while, at another time, the same one or more pumps may be operated to supply a pressure of 2 bars, for example.

As stated above, the fluid dispensing system also comprises a number of fluid dispensers. The fluid dispensers may be configured, for example, as nozzles. At least one of the two or more fluid dispensers may be preferably a telescopic fluid dispenser. The telescopic fluid dispensers may in some cases be of the telescopic type comprising two mutually displaceable bodies such that the position from which fluid is supplied can be varied as required. In other words, the telescopic fluid dispensers typically comprise at least two bodies than can be displaced relative to each other, and a spring member having a specific spring rate opposing the relative movement of the bodies. When fluid pressure is greater than the spring rate, one body is caused to move or extend relative to the other body of the telescopic fluid dispenser while fluid is delivered out of the fluid dispenser. When fluid pressure is lower than the spring rate, i.e., the spring force is greater than that from the fluid pressure, one body is returned to its initial retracted position while fluid flow is ceased. Thus, the fluid dispenser may be capable of extending from a rest position, concealed in the vehicle, to an extended position, and retracting from the extended position to the rest position. The position from which fluid is supplied can be therefore varied as required. Other types of fluid dispensers such as fixed ones are not ruled out as long as they are configured to receive fluid from at least one pump (e.g., two or more pumps) and dispensing it towards at least one target surface or object.

In some examples, the present fluid dispensing system may include at least one non-telescopic fluid dispensers and at least one telescopic fluid dispenser.

In any case, the fluid dispensers may preferably be configured to deliver fluid in a single direction out of the fluid dispensing system. The number of fluid dispensers may be different from the number of pumps, or they may be the same, as required. Also, the number of fluid dispensers may be different from the number of target objects depending, for example, upon the surface size or surface shape of the target object to be washed. For example, a number of fluid dispensers could be used for washing one target object. Fluid lines feeding fluid dispensers may be preferably arranged in parallel.

The fluid dispenser may comprise an inlet, e.g., fluid inlet, and an outlet, e.g., fluid outlet. The inlet may be configured to receive fluid into the fluid dispenser. The outlet may be adapted for ejecting the washing fluid to a surface to be cleaned of the target object. When the fluid dispenser is a telescopic fluid dispenser, it further comprises a second fluid outlet for allowing fluid to flow back away from the at least one telescopic fluid dispenser when retracting from the extended position to the rest position. The at least one control valve may include a control valve assembly, wherein said second fluid outlet of the at least one control valve assembly may be configured for allowing residual fluid trapped within the at least one telescopic fluid dispenser to flow back away therefrom when the at least one telescopic fluid dispenser retracts from the extended position to the rest position. The fluid allowed to flow back away from the at least one telescopic fluid dispenser may be fluid present, e.g., trapped, either within the at least one telescopic fluid dispenser or in a section between the at least one telescopic fluid dispenser and the at least one control valve assembly. The at least one control valve assembly thus comprises at least three ways, that is, the above mentioned fluid inlet for receiving fluid from the at least one fluid source, e.g. from the manifold, the above mentioned first fluid outlet for discharging fluid into the at least one telescopic fluid dispenser, and the second fluid outlet for allowing fluid in the at least one telescopic fluid dispenser to flow back away from the at least one telescopic fluid dispenser when retracting from the extended position to the rest position. Within the above definition, the control valve assembly may be a three-way valve, or it may be a two-way valve operating in association with an additional fluid outlet, that is, the third way, for allowing fluid that may be present in the at least one telescopic fluid dispenser to flow back away from the at least one telescopic fluid dispenser. Other structures and combinations of structures are also possible. In any case, the at least one control valve assembly operates with at least two directions of fluid flowing through the first fluid outlet, that is, a first direction of fluid flowing out through the first fluid outlet and a second direction of fluid flowing into the control valve assembly when the at least one telescopic fluid dispenser retracts from the extended position to the rest position.

In one example of the control valve assembly, it may comprise a valve body including a movable valve element capable of preventing fluid flow from entering the valve body and allowing fluid flow entering the valve body and into the at least one telescopic fluid dispenser while preventing fluid from flowing out of the valve body. In this case, the valve element may for example comprise a rubber membrane capable of being pivoted into at least a first position where fluid is prevented from entering the valve body when no fluid is flowing from the fluid source, and pivoted into a second position by the fluid flowing from the fluid source into the valve body such that fluid is allowed to be supplied into the at least one telescopic fluid dispenser while preventing fluid from flowing out of the valve body.

As explained above, the present fluid dispensing system further comprises at least one control unit configured to operate the at least one pump for supplying fluid according to a received command of washing at least one target object. The control unit may be, for example, an electronic control unit (ECU) associated with the one or more pumps for operating at least one selected pump for the purpose of supplying fluid towards one or more target objects. The control unit is thus configured for generating and/or receiving a command for washing one or more target objects, preferably two o more target surfaces. The control unit is further configured to operate (i.e. select) one or more pumps to be operated, that is, to select which pump or pumps has/have to be operated.

Pump selection by the control unit may depend on one or more of:
pump accumulated wearing or fatigue;
a soiling status or dirtiness condition of a target object;
the nature of the target object such as type or size of the target object;
the location of a target object relative to a pump; and
at least one driving condition, for example, when a motor vehicle where a target object is fitted is moving forward, backwards, or it is stopped or parked.

In one example, when the target objects are optical sensors, each sensor may require of the order of about 30 to 90 cm³ of washing fluid in each washing cycle. A washing cycle may typically last 1 to 3 s.

In order for the control unit to select at least one specific pump depending on pump accumulated wearing or fatigue, as stated above, the control unit is capable to control pump operation. Specifically, the control unit may be configured to monitor at least one change in at least one operating parameter related to the operation of at least one pump. The fact that the control unit may be configured to monitor pump operating parameters refers to the capability of the control unit for monitoring a pump status in order to select the most appropriate pump to be operated for washing a specific target object.

As explained, the control unit may be further configured to operate:
a first control valve for the first fluid dispenser to dispense fluid, preferably, towards at least a first target surface; and
a second control valve for preventing the second fluid dispenser to dispense fluid, preferably, towards at least a second target surface.

It may be further preferred that the first fluid dispenser may be configured to receive fluid from at least a first outlet manifold and dispensing it towards at least the first target surface when the first control valve is actuated by the control unit, wherein the second fluid dispenser may be configured to receive fluid from at least a second outlet manifold and dispensing it towards at least a second target surface when the second control valve is actuated by the control unit.

The control unit may be also configured to determine a volume of fluid present in the fluid source based on said pump operating parameters or on a change thereof as stated above when pumps are arranged at different heights in the fluid source. As stated above, pump height refers both to the height of the pump itself or to the height of its connection to the fluid source.

Pump operating parameters may be one or more of voltage, current, fluid flow rate, or frequency. Frequency and flow rate are preferably taken as indirect measurements that can be calculated based on the voltage and the current or amperage associated with the pumps. Frequency and flow rate may of course be directly determined through suitable sensing devices other than by indirect measurement. As used herein, frequency is referred to the angular speed of a pump rotor per time unit, that is, revolutions per minute.

Thus, there are in general two types of operating parameters to be used. The first operating parameters are voltage and current which are a measured directly. The second operating parameters are those measured indirectly through experimental data which are converted into voltage, current, pressure and flow rate values. The flow rate values can be obtained directly through said flowmeter and pressure values can be obtained directly through a pressure gauge.

Other operating parameters may be of course used such as pump torque. In any case, voltage and current are preferred operating parameters for the control unit to monitor pump operation. Pump voltage is kept substantially stable or constant over time by the control unit, or it may vary only slightly, while pump amperage usually decreases over time due to pump fatigue, wear, or damage.

When a decrease in pump power, which may be determined from a decrease in pump current, is received by the control unit, this is interpreted to mean that the said pump is wearing. This may be determined from flow rate-pressure and/or flow rate-current experimental characteristic curves associated with each pump. The control unit then causes said pump having such detected decreased power to be less used.

As a result, the service life of said pump is advantageously extended.

Also, when a decrease in pump power is received by the control unit, this can be interpreted by the control unit as being due to a fluid level that is somewhat lower than height position of said pump whose power is decreased. The control unit then causes a different pump arranged at a lower height to be operated.

The control unit may be configured to supply the pumps with a voltage from which pump current is measured by the control unit. Pump voltage is kept substantially stable by the control unit. Pump operation is monitored by the control unit through pump current (amperage). In other words, for assessing whether a pump is working well or not, the control unit is input with pump current values which are compared with a predefined operating threshold. For example, current ranging from 0 to 0.5 A may mean that the pump is not operational due to a broken component or due to no fluid (liquid or water) present; current ranging from 0.5 to 1.9 A may mean that no liquid is being supplied but air; current ranging from 2 to 5 A may correspond to optimal values under which the pump is determined to work properly; current ranging from 5.1 to 9.9 A may mean that the liquid is frozen; and current ranging from 10 A or higher may mean a pump abnormal operation caused by short circuit.

Furthermore, the control unit may be configured to monitor pump operation through pump temperature. When a pump is in operation for a long period of time or for many duty cycles, it gets hot which adversely affects pump operation. For example, the control unit may be configured to allow a hot pump to rest, without operating said pump during a suitable period of time, regardless fatigue or other parameters. Pump temperature values may be provided directly from a temperature sensor fitted in the pump itself. In preferred cases however, the control unit may be configured to determine pump temperature from the electrical power or current being consumed by the pump. If high current is being consumed by a pump or a large number of cycles has been performed by a pump, pump temperature may be determined by the control unit in order to allow the pump to rest during a given period of time so as to cool it down.

Proper pump operation can be thus efficiently controlled by the control unit from the power consumption of each pump.

From the above-mentioned fluid parameters, the control unit can determine suitable fluid demands in terms of amount, flow rate, and pressure of fluid that should be delivered towards the target object, and hence pumps to be operated to this effect. Fluid dispensers thus only provide, e.g., spray, a precise amount of fluid towards the target object for proper washing. Suitable fluid demand may be carried out by calculations and processing by the control unit based for example on the above-mentioned flow rate-pressure and flow rate-current experimental characteristic curves associated with the pumps.

With the above control unit, intelligent pump management is advantageously performed by controlling pump status, and also how pumps age with time and usage which typically results in pumps being less efficient and supplying lower flow rate. In the present system, however, when this occurs, other pumps with less wear are operated by the control unit, as a result of which, pump life cycles advantageously become equal and overall service life is advantageously extended.

The control unit checks each pump capacity and decides which one(s) has/have to be operated and to which extent depending on pump operating parameters, soiling status or dirtiness condition of target objects, location of the target objects, nature of the target objects, a specific function of the target objects to be washed, etc.

The control unit not only is capable of selecting pumps to be operated and to which extent based on pump operating parameters and target objects to be washed according to soiling status or dirtiness condition, location, specific function and nature thereof, etc, but it is also capable of prioritizing said selection of pumps to be operated and target objects to be washed.

Regarding prioritizing selection by the control unit of one or more target objects to be washed, this may be based on the location of the target objects relative to the fluid dispensers or based on their position on a motor vehicle together with the condition of the motor vehicle, for example if it is moving forward, backwards, or if it is parked, etc. Thus, for example, considering a situation where a set of sensors in a motor vehicle comprising, for example, a Lidar, one front camera, two side cameras, and a rear camera, are required to be washed. In the event that the control unit of the present fluid dispensing system determines that insufficient flow rate/pressure is available for washing all the sensors at the same time, the control unit will take into consideration and prioritize one or more target objects to be washed depending upon their specific function or their location in the motor vehicle: in this case, the front camera would be prioritized by the control unit to be washed in the event that the motor vehicle where said sensor is fitted is travelling; or if the motor vehicle is moving backwards or being parked, the rear camera would be prioritized by the control unit to be washed in this particular case.

Regarding prioritizing selection by the control unit of one or more pumps to be operated, this may be performed by comparing different operating parameters relating to the operation of the selected pump such as tension and current, with data relating to a detected need for washing at least one target object, that is, soiling status or dirtiness condition of at least one target object. Based on said pump operation parameters, at least one selected pump will be prioritized and selected by the control unit to be operated for supplying fluid into at least one target object.

The control unit may be also configured so as to render operating flow rates stable, preferably among pumps of the same type. This causes fluid dispensers to work stably over time and correlated with temperature.

A further important function that may be implemented to the control unit is causing fluid to be recirculated when pump performance detriment is detected due to usage.

It is important to note that the control unit may be adapted to check active and available pumps. Pumps may also be considered by the control to be not available when they are broken or unusable, so they are required to be replaced, and/or are they no longer working in the same way as they originally worked due for example to wear or failure. A warning signal in this respect may be output to warn an operator about pump status. Checking active and available pumps by the control unit is based on the above-mentioned pump operating parameters.

The control unit may be also adapted to dynamically react to a failure occurring when trying to wash one or more target objects, recalculating washing power available and prioritizing target objects where necessary as stated above to ensure safety in driving.

Additional control units may be provided connected to the pumps for example to monitor at least one operating parameter of at least one pump for assessing operating parameters related to the operation of the pumps. In any case, as stated above, the control unit is configured to monitor pumps based on pump current by supplying them with electric power. Controlling pump current by the control unit may allow the presence of fluid flow to be determined.

The control unit may include at least one processor, a memory and/or other hardware such as input and output devices. The processor may be any type of processor capable of executing software, such as a microprocessor, a digital signal processor, a microcontroller, or the like. The memory may be a hard disk, read only memory (ROM), random access memory (RAM), flash memory, or any other non-volatile storage, or any combination of the above devices, or any other type of non-transitory machine readable storage medium readable by processor capable of storing parameters relating to at least one of the soiling status or dirtiness condition of at least one target object for determining if said at least one target object is required to be washed, the capacity of at least some of the pumps in the system, etc. The memory may further store instructions or data for performing the execution of the method described herein.

The present fluid dispensing system may further include sensor means such as temperature sensor means for providing parameters relating to, for example, the temperature of the fluid flowing through the system. Temperature related parameters can be received by the control unit for the purpose of controlling the operation of at least one pump. In other advantageous examples, the sensor means may output temperature data to a Controller Area Network (CAN) also connected to the control unit so as to be fed by data from the vehicle such as the above-mentioned parameters relating to the temperature.

Fluid parameters such as fluid density or viscosity can be accurately determined. Both parameters are of key importance for assessing whether fluid flows well or not. Fluid temperature affects viscosity and thus the flow rate of fluid that is supplied by the pumps. When fluid is hot, it flows well within the system. On the contrary, however, when fluid temperature is low, for example, to the extent that the fluid becomes frozen or semi-frozen, it does not flow well within the system.

Based on said parameters, more or less pumps may be selected by the control unit to be operated during more or less time and with more or less power depending upon the determined washing requirements of at least one target object, that is, the above-mentioned soiling status or dirtiness condition of at least one target object.

For example, if the temperature of the fluid flowing through the present fluid dispensing system that has been detected either from the CAN or from temperature sensors is determined to exceed a determined temperature threshold, the capacity or power of one or more pumps may be varied accordingly by the control unit. Temperature information other than that of the fluid may be also useful for selecting or more pumps to be operated. In general, suitable fluid parameters may be fed to the control unit for selecting at least one pump to be operated, determining when at least one pump is to be operated, determining the power of said at least one pump being operated, etc. Efficient pump management is thus attained.

Other types of sensors may be also provided. For example, a flowmeter may be provided for measuring the amount of fluid that is supplied from the fluid source. The flowmeter may be used to check the fluid flow rate relative to a theoretical fluid flow rate. A fluid level sensor may be also provided to measure the level of fluid in the fluid source. A dirt sensor configured to determine a dirtiness condition of at least one target object may be also provided.

As stated above, the manifold may further be provided in the present fluid dispensing system. The manifold comprises at least one body comprising one or more inlets into which the fluid is gathered from the pumps and a number of outlets, e.g., two or more outlets, from which the fluid is distributed towards the target object through fluid dispensers. Although it is preferred that the number of inlets of the manifold is different from the number of outlets, the number of inlets and outlets of the manifold may be the same. The manifold may have different geometries and/or architectures as long as it is provided with a first fluid inlet, a first fluid outlet and a second fluid outlet. Therefore, the manifold may comprise one or more housing parts as longs as the fluid may enter the manifold and be distributed to different fluid dispensers as required. The manifold may exclude any control valve therein. It may be possible the manifold used in the present fluid dispensing system may comprise a single chamber. This is, the inlets and outlets of the manifold are preferred to converge within a single manifold chamber to render the assembly compact. Optionally, the single chamber may be a piping provided with one or more inlets and two or more outlets. In one preferred optimal example, a single manifold is provided, although a number of manifolds may be used. In fact, a manifold comprising several chambers is not ruled out. This is, a manifold may be provided with two or more manifold chambers, for example, a first manifold chamber and a second manifold chamber fluidly connected to each other. It may be preferred that the fluid pressure in the first manifold chamber and in the second manifold chamber are substantially the same or similar, e.g., a pressure variation of less than 10%. As explained, in one example, the manifold may have a first manifold chamber. The first manifold chamber may include said at least one inlet and said two or more outlets. The manifold may further include an independent, second manifold chamber fluidly connected to the first manifold chamber, for example, through a duct or pipe. It may be preferred that the manifold used in the present fluid dispensing system may comprise a single chamber and a number of ducts arranged as a single piping. That is, the present manifold may comprise the first manifold chamber and one or more pipes fluidly connected to the one or more outlets of the first manifold chamber. It may be preferred that the fluid pressure in the first manifold chamber and in the one or more pipes are substantially the same or similar, e.g., a pressure variation of less than 10%. Further, the second manifold chamber may be fluidly connected to a first return line which will be described below.

According to one example, a single manifold is provided. In some applications such as in motor vehicles, a number of target objects to be washed may be fitted at different locations in a car. In this case, more than one manifolds arranged to run around the entire perimeter of the car may be provided, such as for example a front manifold and a rear manifold.

As stated above, the at least one control valve may be provided for controlling flow rate of fluid to be delivered to the target object(s). Each control valve may be associated with at least one target object. Said control valve(s) may be arranged between the manifold and the fluid dispensers. Within the present disclosure, between the manifold and the fluid dispensers of course includes the control valve(s) being arranged in the manifold or in the fluid dispenser. Preferably, at least one control valve may be arranged between the manifold and a fluid dispenser outlet. More preferably, at least one control valve may be arranged between a manifold outlet and a fluid dispenser outlet.

It may be preferred the present fluid dispensing system may comprise two control valves associated with two target objects (i.e., target surfaces). This is, the present fluid dispensing system may comprise two or more control valves, wherein at least a first control valve may be associated with a first target object and a second control valve may be associated with a second target object. Further, the first control valve may be arranged between a first manifold outlet and a first fluid dispenser outlet, wherein the second control valve may be arranged between a second manifold outlet and a second fluid dispenser outlet. The control valve(s) may be actuated by the control unit according to command received for washing one or more target objects. If pumps are operated but no control valves actuated, no fluid is supplied.

The number of control valves may be different from the number of fluid dispensers. Thus, one control valve may supply one or more fluid dispensers even though they are all arranged to wash only one target object. This will depend on the size and the nature of the target object to be washed.

The control valves may be directly connected to the control unit but in some cases the control valves may be connected to an intermediate means which in turn is connected to the control unit. It may be preferred that said intermediate means is a CAN bus. Such configuration is important in the event that a large number of target objects are present in which case excessive wiring can be avoided.

Preferably, the present system may further comprise at least one return line defining a fluid return path for recirculating fluid towards the fluid source, said return line being arranged fluidly connecting:
(i) at least one control valve and the fluid source, the at least one control valve is arranged between the manifold and the fluid dispenser(s), including inside at least one fluid dispenser, said at least one control valve being actuated by the control unit for allowing or preventing at least one of the M fluid dispensers to dispense fluid towards at least a target surface; and/or
(ii) a manifold and the fluid source. Said (second) connection may be, for example, (1) (directly) to the (first) connection between the at least one control valve and the fluid source, or (2) (directly) to the fluid source.

In particular, a first return line may be provided fluidly connected to the above mentioned second fluid outlet of the at least one control valve assembly for allowing fluid to flow back away from the at least one telescopic fluid dispenser when the at least one telescopic fluid dispenser retracts from the extended position to the rest position. The first return line may be arranged for discharging backflow of fluid from the at least one telescopic fluid dispenser out of the fluid dispensing system.

In particular, a second return line may be provided fluidly connecting the manifold and the fluid source for recirculating fluid towards the fluid source. Said second return line allows recirculation of fluid ensuring the telescopic fluid dispensers to fully return to their retracted position even in the case that remaining fluid is still present during retracting of the body of the telescopic fluid dispenser. Fluid leaks can be thus efficiently detected by detecting fluid level in the fluid source. An unexpected level of fluid in the fluid source can be determined. A condition when there is no washing liquid at the inlet of the pumps can be also identified.

In other examples, the first return line may be connected to one or more of the second return line, or to the fluid source, or to an additional fluid source, or to the exterior of the assembly. A solenoid valve may be provided somewhere along the return line to control fluid flowing through the return line. When provided, the solenoid valve may be controlled by the control unit. The purpose of the second return line is to perform an auto-check or self-testing function for ensuring a proper operation of the parts in the fluid dispensing system such as for example pumps, valves, and fluid dispensers. For this purpose, the control unit will operate parts in the fluid dispensing system and recirculate fluid through the second return line. With the fluid circuit closed, the control unit will be then capable of determining if fluid recirculation works correctly or not. When it is determined that fluid recirculation is not working correctly, this means that the pump or pumps or the check-valves are not working properly, the control unit will be capable of determining which pumps or check-valves are not working properly switching them on/off as appropriate. Suitable information can be displayed to a user or operator. The second return line may be also useful for detecting fluid leaks. When pumps are provided in the fluid source at different heights, as described above, said second return line allows fluid to be recirculated, and the control unit checks fluid level in the fluid source either permanently or from time to time, for example. For example, when a user takes a motor vehicle after it has been parked for some time, although the fluid dispensing system has not been operated automatically or manually by the user for washing a sensor, the control unit will automatically cause fluid recirculation in the fluid dispensing system in order to determine whether any leaking of fluid exists. In case that leaking of fluid is detected, the user will be warned accordingly.

The (first) return line in the present fluid dispensing system, when provided, allows recirculation of fluid ensuring the telescopic fluid dispensers to fully return to their retracted position even in the case that remaining fluid is still present during retracting of the body of the telescopic fluid dispenser. A solenoid valve may be provided somewhere along the return line to control fluid flowing through the return line. When provided, said solenoid valve may be controlled by the control unit.

The return line in the present fluid dispensing system may be also configured to perform an auto-check or self-testing function. This allows self-checking a proper operation of the parts in the fluid dispensing system such as for example pumps, check-valves, solenoid valves, fluid dispensers, etc. For this purpose, the control unit will operate the pumps, close the solenoid valves, and recirculate fluid through the return line. With the fluid circuit closed, the control unit will be then capable of determining if fluid recirculation works correctly or not. When it is determined that fluid recirculation is not working correctly, this means that the pumps or the check-valves are not working properly, the control unit will be capable of determining which pumps or check-valves are not working properly switching them on/off as appropriate. Suitable information can be displayed to a user or operator.

Furthermore, the return line is also useful for detecting fluid leaks. When pumps are provided in the fluid source at different heights, as described above, the return line allows fluid to be recirculated, and the control unit checks fluid level in the fluid source either permanently or from time to time, for example. For example, when a user takes a motor vehicle after it has been parked for some time, although the fluid dispensing system has not been operated automatically or manually by the user for washing a sensor, the control unit will automatically cause fluid recirculation in the fluid dispensing system in order to determine whether any leaking of fluid exists. In case that leaking of fluid is detected, the user will be warned accordingly.

As stated above, the at least one check valve may be arranged between the one or more pumps and the manifold, including at the one or more pumps or in the manifold. Preferably, the check valve may be arranged at least in one of: (i) the pump; (ii) between a pump and the manifold; and (iii) the manifold. This is, it may be arranged between the one or more pumps and the first or second outlet manifold. More preferably, the check valve may be arranged between the one or more pumps and the first inlet manifold, although in some cases it may be provided in the pump themself or at the first inlet manifold.

More preferably, the at least one check valve may be arranged within the manifold being an integral part of or attached to the manifold. The manifold may comprise a housing that may include, in turn, an inner surface configured to receive at least a portion of the check valve for receiving, e.g. attaching, the check valve. As explained, the check valve may comprise the moving portion such that, in use, fluid pressure may cause the moving portion to turn on an axis when the fluid flows through. It is even more preferred the check valve may comprise a flexible membrane so the moving portion may be a deformable portion. Therefore, the check valve may be configured to have an open position and a close position. In the close position, the check valve may block fluid through the first fluid inlet so as to prevent backflow towards the one or more pumps. In the open position, the fluid in the manifold may cause the moving portion, e.g., deformable portion, to turn on an axis such that the manifold may be configured to distribute the fluid towards at least one fluid dispenser.

It is even more preferred that the manifold housing may comprise a second inner surface configured to abut the check valve in the open position so as to restrict the movement of the check valve. This makes the movable portion, e.g., deformable portion, to only open enough and not more. An advantage may be to allow rapid closure of the check valve, e.g., deformable portion, when the fluid pressure is reduced. A further advantage may be to avoid excessive deformation so as to achieve longer product life span. Preferably, in the open position, the moving portion of the check valve, e.g., deformable portion of the flexible membrane, may have an angle of between 3° to 80° in respect to the closed position, preferably, 5° to 60°, more preferably, an angle of between 10° to 45°, even more preferably, an angle of between 15° to 30°. Furthermore, the check valve may comprise a frame and two or more moving portions, wherein the inner surface of the manifold housing may receive, e.g., be attached to, the frame.

As stated above, the at least one check valve may be also provided for preventing backflow towards the pumps, e.g., towards pumps which are not in use, for example, when two or more inlets are provided in the manifold. As a result of the provision of check valve(s), fluid is caused to flow in a single direction out of the fluid dispensing system, as stated above, that is, from the manifold to the fluid dispensers. Further, the check valve may be advantageously to maintain fluid pressure, e.g., prevent fluid pressure loss, in the piping/manifold. Therefore, it may be important to maintain a certain desired pressure between one or more pumps and a control valve, for example, in the manifold. It may allow the fluid dispensing system to rapidly dispense fluid towards at least one target surface. The above-mentioned control unit may be adapted to operate one pump with all the check valves closed in order to detect valve failure.

With the present fluid dispensing system, any of the pumps can accurately deliver fluid to any fluid dispensing system under the control of the above-mentioned control unit that manages, i.e., selects, prioritizes, and operates, one or more pumps.

The present disclosure further relates to a method for washing at least one portion of at least one target object in a motor vehicle. That is, a method for dispensing a cleaning fluid to a target surface of a motor vehicle is provided in the present disclosure. The method comprises:
receiving a command for washing at least one target object;
preferably, determining if at least one target object is required to be washed (i.e., cleaned);
preferably, determining an amount of fluid for washing (i.e., cleaning) said at least one target object;
preferably, selecting at least one pump according to said determined washing requirement of at least one target object; and
operating a pump (e.g., said selected pump) for dispensing washing fluid (i.e., cleaning fluid) to at least one portion of said at least one target object.

Preferably, the method may comprise actuating at least one control valve being arranged between the manifold and at least one of the plurality of fluid dispensers, including in the manifold or in the at least one of the plurality of fluid dispensers. In turn, it may comprise:
actuating a first control valve for allowing a first fluid dispenser to dispense fluid towards a first target surface according to the command for washing; and/or
actuating a second valve for preventing a second fluid dispenser to dispense fluid towards a second target surface according to the command for washing.

The method may further comprise:
actuating the first control valve for preventing the first fluid dispenser to dispense fluid towards the first target surface according to a second command for washing; and
actuating the second valve for preventing a second fluid dispenser to dispense fluid towards a second target surface according to the second command for washing.

As described above, the washing method may further comprise prioritizing at least one target object to be washed. Prioritizing may refer to the operation of at least one control valve, and/or at least one fluid dispenser, in case that said determined washing requirement of at least one target object is considered to exceed the performance of at least one pump due, for example, to wear, failure, etc.

In the present washing method, prioritizing the operation of at least one control valve may be based on the location or the specific function of at least one target object that is required to be washed, as described above. It is preferred the method may further comprise prioritizing selected pumps to be operated and target objects to be washed. This is, the control unit may prioritize selected pumps based on pump accumulated wearing or fatigue, the location of the target objects relative to the fluid dispensers or based on their position on a motor vehicle together with the condition of the motor vehicle, for example if it is moving forward, backwards, or if it is parked, etc.

At least one operating parameter related to the operation of at least one pump at a given height is determined and compared to a predetermined parameter representative of a proper operation of the pump. If such operating parameter is not at least substantially similar to the predetermined parameter, the method then determines at least one operating parameter related to the operation of at least one further pump at a lower, different height.

The above step of determining at least one operating parameter is repeated until the operating parameter is at least substantially similar to the predetermined parameter. A value corresponding to the height in the fluid source of said pump whose operating parameter is at least substantially similar to the predetermined parameter is provided, indicative of the fluid level in the fluid source.

The present fluid dispensing system, manifold and method provide a number of significant advantages which are set out below.

With the above-described fluid dispensing system, the number of pumps and how they are operated to wash target objects is efficiently determined according to specific target washing requirements. The number of pumps and their corresponding specific operating power to provide a suitable flow rate and pressure of fluid is accurately determined based on soiling status or dirtiness conditions of the target objects, fluid temperature, nature, and specific function of target objects, location or position of target objects, for example relative to the fluid dispensers, operating condition of a motor vehicle where target objects are fitted (motor vehicle moving forward, moving backwards, stopped, parked, etc.), and so forth. Based on one or more of said parameters, washing fluid can be thus supplied into one or more fluid dispensers to be appropriately delivered towards one or more target objects.

When washing requirements are found to be greater than washing availability, the precise number of pumps to be operated is efficiently adjusted and their operation is prioritized. Target objects to be washed are also suitably prioritized according for example to their location and/or their nature and/or their impact on driving as described above, for example, depending upon when a motor vehicle where a target object is fitted is moving forward, backwards, or it is stopped or parked.

Pump power and washing requirements can be suitably balanced so as to provide efficient washing operation. As a result, the present fluid dispensing system has been found to be extremely advantageous in extending pump service life. Parts in the system such as pumps wear equally.

In addition, with the present fluid dispensing system the quantity of fluid remaining in a fluid source in certain checkpoints can be properly assessed. The amount of fluid that is delivered can be estimated considering factory settings and machine learning adjustment in use. A self-learning feature may be implemented to correct estimation errors.

Also, as stated above referring to the return line, fluid leaks can be efficiently detected by detecting fluid level in the fluid source. An unexpected level of fluid in the fluid source can be determined. A condition when there is no water at the inlet of the pumps can be also identified.

Also, a total or partial blockage in the operation of parts in the present fluid dispensing system such as pumps, fluid dispensers, and solenoid valves can be identified when fluid is not properly reaching at least one target object.

Furthermore, the present fluid dispensing system has been found to be useful for calculating fluid consumption from operating parameters of the pumps such as current and the flow rate of fluid that is delivered.

A further important advantage of the present fluid dispensing system relates to diagnostic functions. Pumps can be determined to be replaced when an abnormal change in current intensity is detected. For example, when current abnormally raises after a working period of time, which may be due for example to a pump engine coil that may be in whole or in part short-circuited, such pump can be determined to be replaced. In addition, power failures can be also detected when no current flows when voltage is being applied. This would mean loss of electrical contact or failure in leading wires, for example. Also, rotor blockages can be detected when current amperage in pumps raises up to a locked rotor intensity value, which would mean that rotor may be blocked due for example to freezing as a result of, for example, improper use of cooling fluid. Furthermore, a low amperage problem in pumps can be detected when they are operated but do not pump. This may be due to abnormally low pump amperage indicative of air suction by the pump or priming failure.

### BRIEF DESCRIPTION OF THE DRAWINGS

A non-limiting example of the present disclosure will be described in the following, with reference to the appended drawings:

FIG. 1 is a diagram that diagrammatically shows a fluid dispensing system, in accordance with a non-limiting example;

FIG. 2 is a diagram that diagrammatically shows the fluid dispensing system, in accordance with another non-limiting example;

FIG. 3 is a perspective view of an inlet side of a manifold of the fluid dispensing system, in accordance with a non-limiting example;

FIG. 4 is a perspective view of an outlet side of the manifold of FIG. 2, in accordance with a non-limiting example;

FIG. 5 is a disassembled view of the manifold of FIG. 3, in accordance with a non-limiting example;

FIG. 6 is a partial cross-sectional perspective view of the manifold of FIG. 4 taken through the line 6-6 depicting a check valve of the manifold in a closed configuration, in accordance with a non-limiting example;

FIG. 7 is a cross-sectional side view of the manifold of FIG. 4 taken through the line 6-6, in accordance with a non-limiting example;

FIG. 8 is a partial cross-sectional perspective view of the manifold of FIG. 6 depicting a check valve of the manifold in an open configuration, in accordance with a non-limiting example;

FIG. 9 is a disassembled side view of the manifold of FIG. 3, in accordance with a non-limiting example;

FIG. 10 is a cross-sectional side view of the manifold of the fluid dispensing system illustrating fluid flow through the check valve, in accordance with a non-limiting example;

FIG. 11 is an elevational view of the manifold of the fluid dispensing system showing interconnected check valves positioned over fluid inlets, in accordance with a non-limiting example;

FIGS. 12A, 12B, 12c and 12D are a schematic view of the dispensing fluid system, in accordance with different possible non-limiting examples;

FIG. 13A depicts a ring circuit connected to the manifold of the fluid dispensing system, in accordance with a non-limiting example; and

FIG. 13B depicts multiple ring circuits connected to the manifold of the fluid dispensing system, in accordance with a non-limiting example.

### DETAILED DESCRIPTION OF ONE EXAMPLE

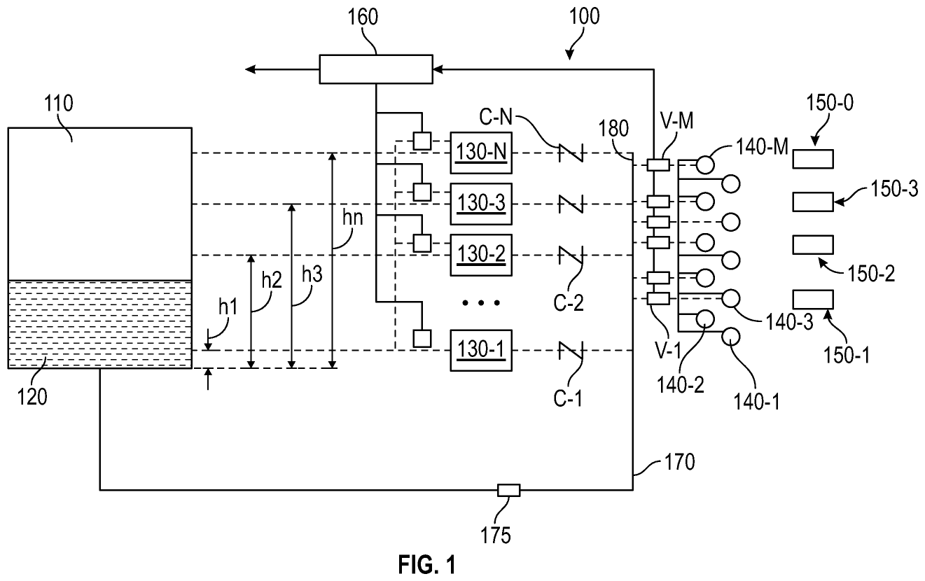

With reference to the FIG. 1, one example of an arrangement of the fluid dispensing system for washing (i.e., cleaning) at least one portion of at least one target object or surface, e.g. target surface, 150-1, 150-2, 150-3, . . . , 150-O in a motor vehicle has been depicted.

The arrangement includes a fluid dispensing system indicated as a whole by reference numeral 100 in FIG. 1. In the example shown, the fluid dispensing system 100 is intended for washing surfaces of parts, i.e. target objects 150-1, 150-2, 150-3, . . . , 150-O, in a motor vehicle. A target object 150-1, 150-2, 150-3, . . . , 150-O in the example shown may be for example a number of different objects such as a Lidar, cameras, windshields, sensors or sensor covers. Target objects 150-1, 150-2, 150-3, . . . , 150-O may have different cleaning requirements according to their soiling status or dirtiness condition so they may require different amounts of fluid for being properly washed. Those skilled in the art will however readily recognize that applications other than the one described herein are of course possible.

The fluid dispensing system 100 comprises at least one fluid source 110. In this example, the fluid source is a tank 110 suitable to contain a washing liquid 120 therein. Connected to the tank 110 is a number N of radial turbo centrifugal pumps 130-1, 130-2, 130-3, . . . , 130-N configured to be supplied with said the washing liquid 120 from the tank 110 with an operating pressure of 2-3 bar and a flow rate of 0-5000 cm³/min and in general of the order of 2000 to 3000 cm³/min. In the example shown, the points where the pumps 130-1, 130-2, 130-3, . . . , 130-N are connected to the fluid source 110 are arranged at different heights h1, h2, h3, . . . , hn to the ground. The pumps 130-1, 130-2, 130-3, . . . , 130-N are arranged in parallel to each other, that is, fluid lines associated with the pumps 130-1, 130-2, 130-3, . . . , 130-N are arranged in parallel. Other configurations with pumps 130-1, 130-2, 130-3, . . . , 130-N arranged in series may be possible, if required.

A number M of fluid dispensers 140-1, 140-2, 140-3, . . . , 140-M is also provided. In the present example, at least one fluid dispenser is of the non-telescopic type each comprising a nozzle 140-1, 140-2, 140-3, . . . , 140-M configured to deliver the washing liquid 120 pumped by pumps 130-1, 130-2, 130-3, . . . , 130-N towards at least one target object 150-1, 150-2, 150-3, . . . , 150-O. It is to noted that a single nozzle 140-1, 140-2, 140-3, . . . , 140-M may supply washing liquid 120 to one target object 150-1, 150-2, 150-3, . . . , 150-O or to a number of target objects 150-1, 150-2, 150-3, . . . , 150-O. Also, a number of single nozzles 140-1, 140-2, 140-3, . . . , 140-M may supply washing liquid 120 to one target object 150-1, 150-2, 150-3, . . . , 150-O or to a number of target objects 150-1, 150-2, 150-3, . . . , 150-O as required. As with the pumps 130-1, 130-2, 130-3, . . . , 130-N, fluid lines feeding the nozzles 140-1, 140-2, 140-3, . . . , 140-M may be preferably arranged in parallel.

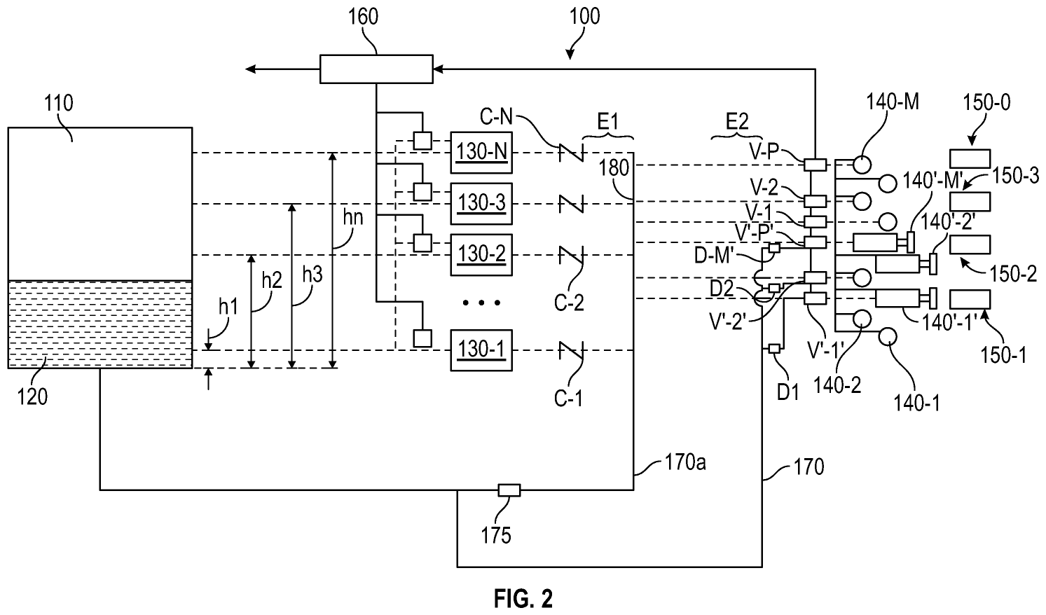

In the present non-limiting example of FIG. 2, at least one nozzle 140′-1′, 140′-2′, . . . , 140′-M′ is of the telescopic type. The nozzles 140′-1′, 140′-2′, . . . , 140′-M′, comprise two bodies, not shown, then can be displaced relative to each other, and a spring member, not shown. When the pressure of the washing liquid 120 is greater than the spring rate, one body is caused to move or extend relative to the other body of the nozzle 140′-1′, 140′-2′, . . . , 140-M while the washing liquid 120 is delivered out to one or more target objects 150-1, 150-2, 150-3, . . . , 150-O. When the pressure of the washing liquid 120 that is being supplied is lower than the spring rate such that the spring force is greater than that from the pressure of washing liquid 120, one body of the telescopic nozzle 140′-1′, 140′-2′, . . . , 140′-M′ is returned to its initial retracted position while the flow of washing liquid 120 is ceased. The telescopic fluid dispensers 140′-1′, 140′- 2′, . . . , 140′-M′ are thus capable of extending from a rest position, concealed in a motor vehicle surface, to an extended position and retracting from the extended position to the rest position, concealed again in the motor vehicle surface.

The number M of nozzles 140-1, 140-2, 140-3, . . . , 140-M may be different from the number N of pumps 130-1, 130-2, 130-3, . . . , 130-N, or they may be the same, as required. On the other hand, the number M of nozzles 140-1, 140-2, 140-3, . . . , 140-M may be different from the number of target objects 150-1, 150-2, 150-3, . . . , 150-O depending on the size of the target objects 150-1, 150-2, 150-3, . . . , 150-O to be washed, for example.

At least one control unit 160 is provided. Specifically, an electronic control unit (ECU) 160 is provided. The ECU 160 is configured to select one or more pumps 130-1, 130-2, 130-3, . . . , 130-N and operate said one or more pumps 130-1, 130-2, 130-3, . . . , 130-N for supplying washing liquid 120 to one or more nozzles 140-1, 140-2, 140-3, . . . , 140-M to wash one or more target objects 150-1, 150-2, 150-3, . . . , 150-O according to one or more of the following:
a command for washing at least one target object 150-1, 150-2, 150-3, . . . , 150-O according to a detected soiling status or dirtiness condition of the target objects 150-1, 150-2, 150-3, . . . , 150-O, or at the request of a user;
pump accumulated wearing or fatigue, i.e. a condition of the pumps 130-1, 130-2, 130-3, . . . , 130-N, which may be carried out by the ECU 160 based on flow rate-pressure and flow rate-current characteristic curves of the pumps 130-1, 130-2, 130-3, . . . , 130-N, and specifically through pump operating parameters such as voltage, current, fluid flow rate, frequency or torque, with current being the most preferred;
the nature of the target objects 150-1, 150-2, 150-3, . . . , 150-O to be washed;
a function of the target objects 150-1, 150-2, 150-3, . . . , 150-O relative to the nozzles 140-1, 140-2, 140-3, . . . , 140-M.

The ECU 160 is capable of adjusting pump parameters such as fluid flow rate and fluid pressure according to the need for at least one target object 150-1, 150-2, 150-3, . . . , 150-O to be washed. For example, when a number of target objects 150-1, 150-2, 150-3, . . . , 150-O is determined by the ECU 160 to be washed, a specific number of pumps 130-1, 130-2, 130-3, . . . , 130-N is selected by the ECU 160 to deliver for example about 30 to 90 cm³ of washing liquid 120 in each washing cycle for each target object 150-1, 150-2, 150-3, . . . , 150-O. A washing cycle may typically last 1 to 3 s. A suitable amount of washing liquid 120 can be thus delivered to target object 150-1, 150-2, 150-3, . . . , 150-O for properly washing them.

The ECU 160 is also capable of adjusting pump operation according to said operating parameters. For example, when pump current, i.e., pump power, below a given threshold is detected, this is interpreted by the ECU 160 to mean that the pump 130-1, 130-2, 130-3, . . . , 130-N is wearing. The ECU 160 will then cause said pump 130-1, 130-2, 130-3, . . . , 130-N to be less used, that is, a lower power is supplied to said pump 130-1, 130-2, 130-3, . . . , 130-N based on the above-mentioned characteristic curves.

If for example pump current values are of 2-4 A such as 3 A, a pump 130-1, 130-2, 130-3, . . . , 130-N is determined to work properly. If pump current values are out of said predefined operating threshold, this means that the pump 130-1, 130-2, 130-3, . . . , 130-N is malfunctioning. For example, a pump current value of about 0 A may mean that the pump 130-1, 130-2, 130-3, . . . , 130-N is not operational due to a broken component. For example, pump current value of about 1 A may mean that no liquid is being supplied but air. For example, pump current value of about 7 or 8 A may mean that the liquid is frozen. Depending on the power of the pump 130-1, 130-2, 130-3, . . . , 130-N, the pump current value may reach 10 A when the liquid is frozen. A pump abnormal operation caused by short circuit may correspond for example to a pump current value of about 10 A or higher.

As stated above, the ECU 160 is also capable of prioritising pumps 130-1, 130-2, 130-3, . . . , 130-N to be operated, and prioritising target objects 150-1, 150-2, 150-3, . . . , 150-O to be washed, as described below.

Prioritisation of pumps 130-1, 130-2, 130-3, . .. , 130-N by the ECU 160 may be performed by comparing different operating parameters relating to the operation of at least one pump 130-1, 130-2, 130-3, . . . , 130-N, such as for example voltage and current, with data relating to the detected need for washing target objects 150-1, 150-2, 150-3, . . . , 150-O. Based on said pump operation parameters, at least one selected pump 130-1, 130-2, 130-3, . . . , 130-N will be operated by the ECU 160 for appropriately supplying washing liquid 120 into at least one target object 150-1, 150-2, 150-3, . . . , 150-O.

Prioritisation of target objects 150-1, 150-2, 150-3, . . . , 150-O by the ECU 160 may be performed, as stated above, according to their intended function. When a set of target objects 150-1, 150-2, 150-3, . . . , 150-O comprising for example a Lidar, front cameras, side cameras, and a rear camera, is required to be washed, and flow rate and/or pressure of the washing liquid 120 is considered by the ECU 160 not to be available or sufficient for properly washing all those target objects 150-1, 150-2, 150-3, . . . , 150-O at the same time, the ECU 160 then prioritizes one or more target objects 150-1, 150-2, 150-3, . . . , 150-O to be washed depending upon a specific function of the target objects 150-1, 150-2, 150-3, . . . , 150-O to be washed, and then selects one or more pumps 130-1, 130-2, 130-3, . . . , 130-N and/or nozzles 140-1, 140-2, 140-3, . . . , 140-M accordingly. For example, under this situation, the front camera in said set of target objects 150-1, 150-2, 150-3, . . . , 150-O will be prioritized by the ECU 160 in the event that the motor vehicle where the front camera is fitted is moving forward. A rear camera will be prioritized by the ECU 160 in the event that the motor vehicle where the rear camera is fitted is moving backwards.

The above-mentioned parameters relating to the operation of at least one pump 130-1, 130-2, 130-3, . . . , 130-N, may also be used by the ECU 160 to determine the presence of fluid flow in the system 100.

On the other hand, the ECU 160 is also capable of detecting, based on said pump operating parameters, when a pump 130-1, 130-2, 130-3, . . . , 130-N is completely broken or unusable, and if it is required to be replaced.

As stated above, pumps 130-1, 130-2, 130-3, . . . , 130-N in the example being described are arranged in the tank 110 such that their respective connections to the tank 110 are arranged at different heights h1, h2, h3, . . . , hn to the ground in the non-limiting example describe herein. Arranging pumps 130-1, 130-2, 130-3, . . . , 130-N at different heights h1, h2, h3, . . . , hn in the tank 110 allows a volume of washing liquid 120 present in the tank 110 to be accurately determined by the ECU 160 based on the above-mentioned pump operating parameters, such as voltage, current, washing liquid flow rate, frequency and so on. When a pump 130-1, 130-2, 130-3, . . . , 130-N is operated, it could happen that the pump 130-1, 130-2, 130-3, . . . , 130-N draws air instead of fluid because of fluid level in the tank 110 located below the pump 130-1, 130-2, 130-3, . . . , 130-N, in which case pump current will be the operating parameter to be used. On the other hand, when a pump 130-1, 130-2, 130-3, . . . , 130-N is operated and fluid is drawn because fluid level in the tank 110 is above the pump 130-1, 130-2, 130-3, . . . , 130-N, then pump voltage will be the operating parameter to be used.

The fact that accurately determining a volume of washing liquid 120 in the tank 110 is carried out based on said operating parameters means that the ECU 160 is fed with at least one of said operating parameters associated with the pumps 130-1, 130-2, 130-3, . . . , 130-N. Said operating parameters are compared with predetermined operating parameters for the purpose of assessing changes in operating parameters and if they are within predetermined or acceptable ranges.

Also, arranging pumps 130-1, 130-2, 130-3, . . . , 130-N with their connections to the tank 110 located at different heights h1, h2, h3, . . . , hn allows the ECU 160 to select one or more pumps 130-1, 130-2, 130-3, . . . , 130-N at lower levels in the tank 110 when a given pump 130-1, 130-2, 130-3, . . . , 130-N at a higher level in the tank 110 is determined not to work properly.

Intelligent pump management is thus advantageously performed by the ECU 160 through pump status control. Pumps 130-1, 130-2, 130-3, . . . , 130-N detected to be with less wear can be appropriately selected by the ECU 160 to be operated. Pump age over time and usage is accurately controlled and service life of different parts such as pumps 130-1, 130-2, 130-3, . . . , 130-N, nozzles 140-1, 140-2, 140-3, . . . , 140-M, etc. is advantageously extended, while overall system efficiency is increased.

The ECU 160 is also capable of checking active and available pumps 130-1, 130-2, 130-3, . . . , 130-N. Pumps 130-1, 130-2, 130-3, . . . , 130-N may be considered by the ECU 160 to be not available for example when they are located far from the target objects 150-1, 150-2, 150-3, . . . , 150-O, or when they are located at a great height h1, h2, h3, . . . , hN in the tank 110, above fluid height. Pumps 130-1, 130-2, 130-3, . . . , 130-N may also be considered not to be available when they are broken and/or are no longer working in the same way as they originally worked due for example to wear.

In addition, the ECU 160 is also capable to dynamically react to a failure occurring when trying to wash one or more target objects 150-1, 150-2, 150-3, . . . , 150-O, recalculating washing power available and prioritizing target objects 150-1, 150-2, 150-3, . . . , 150-O again where necessary to ensure safety in driving.

The ECU 160 in the present example is suitable to render operating flow rates stable among pumps 130-1, 130-2, 130-3, . . . , 130-N of the same type. Pumps 130-1, 130-2, 130-3, . . . , 130-N are thus caused to work stably over time and correlated with temperature. Also, the ECU 160 in the present example is capable of causing washing liquid 120 to be recirculated when pump performance detriment is detected due to usage. Other capabilities of the ECU 160 in the present example is to operate one pump 130-1, 130-2, 130-3, . . . , 130-N with the valves present in the circuit in a closed state in order to detect valve failures or leaks.

Also provided in the arrangement having the present fluid dispensing system 100 is a manifold 180. Manifold 180 comprises a body with a number of inlets into which washing liquid 120 is gathered from the above-mentioned N pumps 130-1, 130-2, 130-3, . . . , 130-N, and a number of outlets from which the washing liquid 120 is distributed towards the target objects 150-1, 150-2, 150-3, . . . , 150-O via nozzles 140-1, 140-2, 140-3, . . . , 140-M. The number of outlets and the number of inlets in the manifold 180 may be the same or different from each other. Manifold 180 comprises a first manifold chamber 180′ wherein the inlets and outlets of the first manifold chamber 180′ converge within a single manifold chamber to render the assembly compact. Thus manifold 180 used herein comprises a single manifold chamber 180′ and possibly, a number of ducts fluidly connecting the manifold chamber and the fluid dispensers (e.g. the two or more ducts fluidly connecting the manifold chamber 180′ and the control valves), and a number of ducts fluidly connecting the manifold chamber 180′ and the above mentioned N pumps 130-1, 130-2, 130-3, . . . , 130-N.

A number P of control valves V-1, V-2, . . . , V-P is arranged between the manifold 180 and the nozzles 140-1, 140-2, 140-3, . . . , 140-M. Control valves V-1, V-2, . . . , V-P are connected to the ECU 160 for controlling the flow rate of washing liquid 120 to be delivered to the target objects 150-1, 150-2, 150-3, . . . , 150-O.

The arrangement with the present fluid dispensing system 100 further includes a number N of check valves C-1, C-2, . . . , C-N arranged between the pumps 130-1, 130-2, 130-3, . . . , 130-N and the manifold 180 to prevent backflow of washing liquid 120 towards the pumps 130-1, 130-2, 130-3, . . . , 130-N which are not in use. The washing liquid 120 thus only flows in a single direction out of the fluid dispensing system 100, from the manifold 180 to the nozzles 140-1, 140-2, 140-3, . . . , 140-M.

Each check-valve valve V′-1, V′-2, . . . , V′-P′ may be arranged together forming thus a check valve assembly. Said check valve assembly comprises a valve body 190 having at least one fluid inlet for receiving washing liquid 120 from the one or more pumps according to a fluid intake direction, at least one first fluid outlet for discharging washing liquid 120 into the fluid dispenser 140-1, 140-2, 140-3, . . . , 140-M according to a first flow direction of washing liquid 120 flowing out through said first fluid outlet.

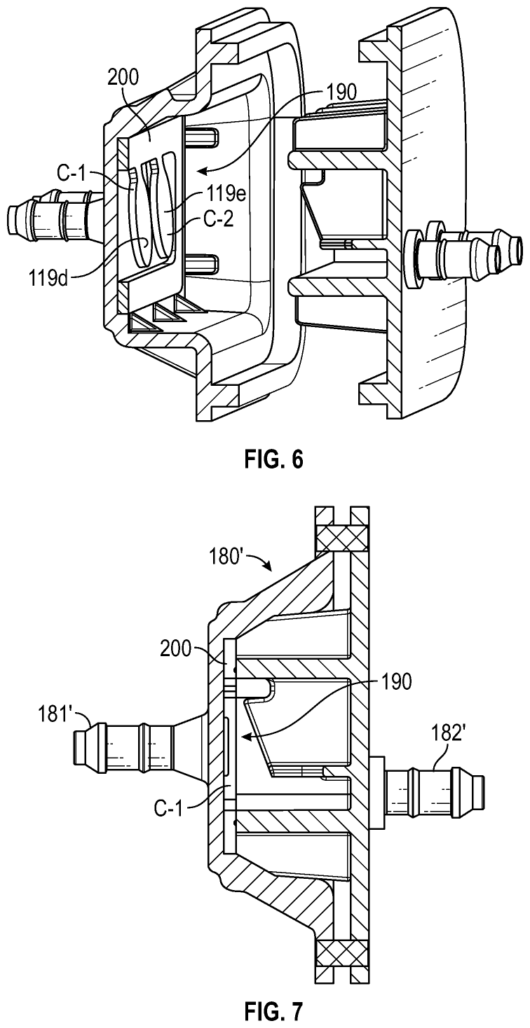

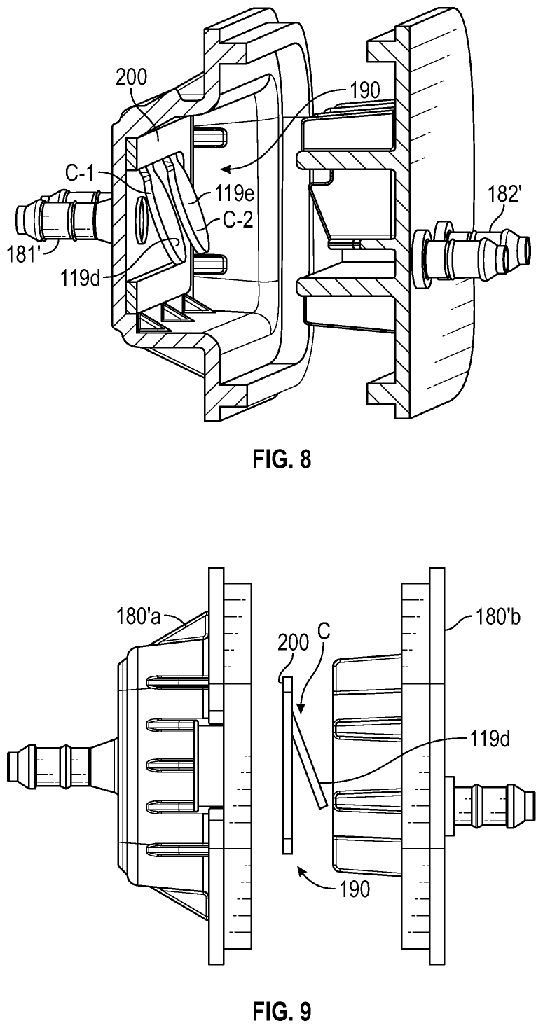

Within the check valve body, a movable valve element is provided. The movable valve element is, in this example, a rubber membrane capable of being pivoted into at least a first end position (FIGS. 6 and 7) closing the fluid inlet such that washing liquid 120 is prevented from entering the valve body 190 when no washing liquid 120 is flowing from the tank 110. The rubber membrane 194 is also capable of being pivoted into a second end position (FIGS. 8 and 9) pushed by washing liquid 120 flowing through the 25 fluid inlet 191 from the tank 110 into the valve body 190 such that washing liquid 120 is allowed to flow through the first fluid outlet 192 into the telescopic fluid dispenser 140′-1′, 140′-2′, 140′-3′, . . . , 140′-M′ according to the above mentioned first flow direction while it is prevented from flowing through the second fluid outlet 193 according to the fluid backflow direction 120(4) out of the valve body 190. The rubber 30 membrane 194 may be pivoted from the first end position 194′ to the second end position 194″ against the action of a spring, not shown. The rubber membrane 194 may be also pivoted into different intermediate positions other than said first and second end positions 194′, 194″.

FIG. 2 shows the control valves V-1, V-2, . . . , V-P are also provided between the manifold 180 and the non-telescopic fluid dispensers 140-1, 140-2, 140-3, . . . , 140-M. The control valves V-1, V-2, . . . , V-P are thus associated with corresponding non-telescopic fluid dispensers 140-1, 140-2, 140-3, . . . , 140-M. Control valves V-1, V-2, . . . , V-P are actuated by the control unit 160. In this case, the above-mentioned solenoid valve 175 is arranged between the tank 110 and the control valves V-1, V-2, . . . , V-P and/or the control valve assemblies V′-1, V′-2, . . . , V′-P′.

As shown, the return line 170 allows residual washing liquid trapped within the telescopic fluid dispenser 140′-1′, 140′-2′, 140′-3′, . . . , 140′-M′ to flow back away therefrom when the at least one telescopic fluid dispenser 140′-1′, 140′-2′, 140′-3′, . . . , 140′-M′ retracts into the rest position.

FIG. 2 shows that the control valve associated with the telescopic dispenser includes a control valve assembly that comprises a first flid inlet, a first fluid outlet and a second fluid outlet. The second fluid outlet of the control valve assembly V′-1, V′-2, . . . , V′-P′ is connected to the first return line 170 which in turn fluidly connects the manifold 180 and the tank 110. Washing liquid 120 is allowed to flow towards the tank 110 resulting in that the telescopic fluid dispensers 140′-1′, 140′-2′, 140′-3′, . . . , 140′-M′ can be fully returned back to their retracted position, concealed in a vehicle, even in the case that remaining washing liquid 120 is still present therein during retracting movement or after a washing operation is complete. The first return line 170, however, could be connected to other locations such as an additional tank, or out of the fluid dispensing system 100, or even to a second return line 170a which is described below.

A solenoid valve 175 is provided in the second return line 170a and connected to the control unit 160 for controlling washing liquid 120 flowing therethrough. A second return line 170a fluidly connects the manifold 180 and the tank 110 for recirculating fluid 120 towards the tank 110. The second return line 170a allows the ECU 160 to perform an auto-check or self-testing function for self-checking operation of one or more of the pumps 130-1, 130-2, 130-3, . . . , 130-N, check valves C-1, C-2, . . . , C-N, solenoid valves 175, fluid dispensers 140-1, 140-2, 140-3, . . . , 140-M; 140′-1′, 140′-2′, 140′-3′, . . . , 14′0-M′, etc. Auto-check function is performed by the ECU 160 by operating pumps 130-1, 130-2, 130-3, . . . , 130-N and closing solenoid valves 175 causing washing liquid 120 to recirculate through second return line 170a. This allows the ECU 160 to assess whether pumps 130-1, 130-2, 130-3, . . . , 130-N and check valves C-1, C-2, . . . , C-N are working properly, for example. Leaks of washing liquid 120 in the circuit can be also detected by controlling the level of washing liquid 120 in the tank 110 when recirculation is performed. Alternatively, or in addition, a fluid level controller may be provided for controlling the level of washing liquid 120 in the tank 110.

A number M′ of check-valves D1, D2, . . . , DM′ is provided. Each check-valve D1, D2, . . . , DM′ is fluidly connected to the control valve assembly V′-1, V′-2, . . . , V′-P′. The check-valves D1, D2, . . . , DM′ serve the purpose of preventing backflow of fluid from the one telescopic fluid dispensers 140′-1, 140′-2, 140′-3′, . . . , 140′-M′ into another telescopic fluid dispenser 140′-1′, 140′-2′, 140′-3′, . . . , 140′-M′.

Another number N of check- valves C-1, C-2, . . . , C-N is provided the pumps 130-1, 130-2, 130-3, . . . , 130-N and the manifold 180 to prevent backflow of washing liquid 120 towards the pumps 130-1, 130-2, 130-3, . . . , 130-N which are not in use. The washing liquid 120 thus only flows in a single direction out of the fluid dispensing system 100, from the manifold 180 to the fluid dispensers 140-1, 140-2, 140-3, . . . , 140-M; 140′-1, 140′-2, 140′-3′, . . . , 140′-M′.

The ECU 160 is also configured to be fed with temperature values from the washing liquid 120 flowing through the fluid dispensing system 100. From said temperature values of the washing liquid 120, the ECU 160 can further monitor operation of pumps 130-1, 130-2, 130-3, . . . , 130-N. Temperature values of the washing liquid 120 can be supplied from at least one temperature sensor or from a motor vehicle Controller Area Network (CAN), not shown. Temperature related parameters of the washing liquid 120 such as viscosity may be also fed to the ECU 160. For example, if the temperature of the washing liquid 120 flowing through the fluid dispensing system 100 is determined by the ECU 160 to exceed a determined threshold, the power of one or more pumps 130-1, 130-2, 130-3, . . . , 130-N may be varied accordingly by the ECU 160.

As described above, the nozzles 140-1, 140-2, 140-3, . . . , 140-M are of the telescopic type. In order to ensure that they fully return to their retracted position even in the case that remaining washing liquid 120 is still present during retracting movement, a return line 170 is included. The return line 170 is arranged fluidly connecting the manifold 180 and the tank 110 for recirculating washing liquid 120 towards the tank 110. A solenoid valve 175 provided in the return line 170 is connected to the ECU 160 for controlling washing liquid 120 flowing therethrough.

Including a return line 170 in the circuit of the present fluid dispensing system 100 allows the ECU 160 to perform an auto-check or self-testing function for self-checking operation of one or more of the pumps 130-1, 130-2, 130-3, . . . , 130-N, check valves C-1, C-2, . . . , C-N, solenoid valves 175, nozzles 140-1, 140-2, 140-3, . . . , 140-M, etc. Auto-check function is performed by the ECU 160 by operating pumps 130-1, 130-2, 130-3, . . . , 130-N and closing solenoid valves 175 causing washing liquid 120 to recirculate through return line 170. This allows the ECU 160 to assess whether pumps 130-1, 130-2, 130-3, . . . , 130-N and check valves C-1, C-2, . . . , C-N are working properly, for example. Leaks of washing liquid 120 in the circuit can be also detected by controlling the level of washing liquid 120 in the tank 110 when recirculation is performed. Alternatively, or in addition, a fluid level controller may be provided for controlling the level of washing liquid 120 in the tank 110.

A washing operation using the present arrangement having the present fluid dispensing system 100 described above is as follows. First, a command for washing at least one target object 150-1, 150-2, 150-3, . . . , 150-O is received by the ECU 160 or a washing command is received at the request of the user. In some cases, target object washing requirements may be determined based on which a washing command is output. The ECU 160 then prioritizes one or more of said target objects 150-1, 150-2, 150-3, . . . , 150-O that have been determined to require washing according to a soiling status or dirtiness condition of the target objects 150-1, 150-2, 150-3, . . . , 150-O. The ECU 160 then determines which target objects 150-1, 150-2, 150-3, . . . , 150-O have to be washed according to said soiling status or dirtiness condition, that is, the ECU 160 determines one or more of pressure, amount, and flow rate of washing liquid 120 to be delivered. The ECU 160 then selects, and in some cases prioritizes, a number of pumps 130-1, 130-2, 130-3, . . . , 130-N according to said washing requirement. Selected pumps 130-1, 130-2, 130-3, . . . , 130-N are operated according to said washing requirement with specific power for delivering (e.g. spraying) a suitable flow rate of washing liquid 120 with a given pressure towards selected target objects 150-1, 150-2, 150-3, . . . , 150-O.

Prioritizing target objects 150-1, 150-2, 150-3, . . . , 150-O to be washed and pumps 130-1, 130-2, 130-3, . . . , 130-N to be operated are performed by the ECU 160 in case that said determined washing requirement of at least one target object 150-1, 150-2, 150-3, . . . , 150-O is considered to exceed the performance of at least one pump 130-1, 130-2, 130-3, . . . , 130-N due, for example, to wear, failure, etc.

Prioritizing target objects 150-1, 150-2, 150-3, . . . , 150-O and pumps 130-1, 130-2, 130-3, . . . , 130-N may be also performed by the ECU 160 based on the specific a specific function of the target objects 150-1, 150-2, 150-3, . . . , 150-O to be washed as stated above.

In the non-limiting example shown in the figure in which points where pumps 130-1, 130-2, 130-3, . . . , 130-N are connected to the tank 110 are at different heights h1, h2, h3, . . . , hn, said one or more parameters related to the operation of pumps 130-1, 130-2, 130-3, . . . , 130-N at said corresponding heights h1, h2, h3, . . . , hn are determined by the ECU 160 for the purpose of calculating a volume of washing liquid 120 present in the tank 110. Specifically, the ECU 160 is fed with one or more pump operation parameters at a given height h1, h2, h3, . . . , hn. Said operating parameters are compared to predetermined operating parameters representative of a proper operation of the pump 130-1, 130-2, 130-3, . . . , 130-N arranged at said height h1, h2, h3, . . . , hn. If the pump operating parameter input to the ECU 160 is not at least substantially similar to the predetermined operating parameter, at least one operating parameter related to the operation of at least one further pump 130-1, 130-2, 130-3, . . . , 130-N whose tank connecting point is arranged at a lower height h1, h2, h3, . . . , hn is then input to the ECU 160. This is repeated until the operating parameter input to the ECU 160 is at least substantially similar to the predetermined parameter. A value corresponding to the height h1, h2, h3, . . . , hn in the tank 110 where said further pump 130-1, 130-2, 130-3, . . . , 130-N is located whose operating parameter is at least substantially similar to the predetermined parameter is given indicative of a height h1, h2, h3, . . . , hn in the tank 110 where there is washing liquid 120.

Although only a number of examples of said fluid dispensing system, manifold and washing method (i.e., cleaning method) have been disclosed herein, other alternatives, modifications, uses and/or equivalents thereof are possible.

Furthermore, all possible combinations of the described examples are also covered. Thus, the scope of the present disclosure should not be limited by particular examples but should be determined only by a fair reading of the claims that follow. Reference signs related to drawings placed in parentheses in a claim are solely for attempting to increase the intelligibility of the claim and shall not be construed as limiting the scope of the claim.

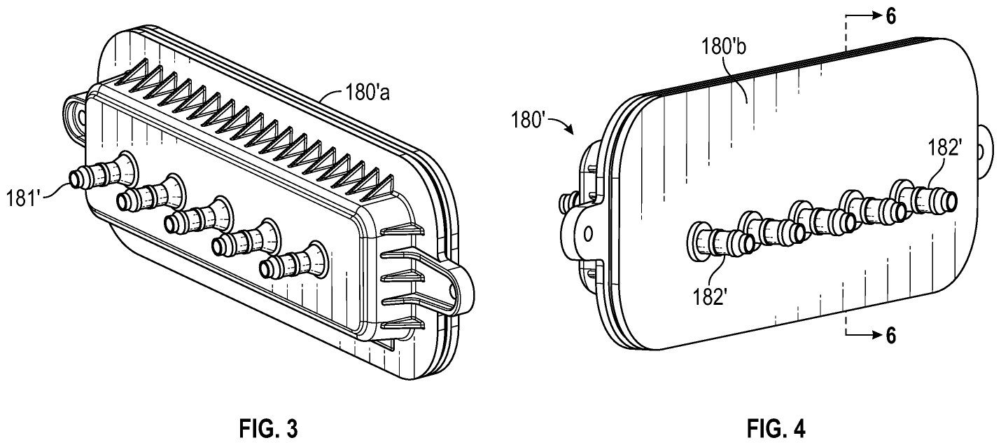

FIGS. 3 and 4 show a manifold 180 comprising a first manifold chamber body defining a body therein. The first manifold chamber comprises two housing parts 180a, 180b that can be attached one another so as to define an inner space therein. First housing part 180a defined an inlet housing portion and second housing part 180b defines an outlet housing part. As shown in the example, the first manifold chamber has five inlets manifold 181 into which the fluid 120 is gathered from the pumps 130-1, 130-2, 130-3, . . . , 130-N and five outlets manifold 182 from which the fluid 120 is distributed towards the target objects 150-1, 150-2, 150-3, . . . -, 150-O.

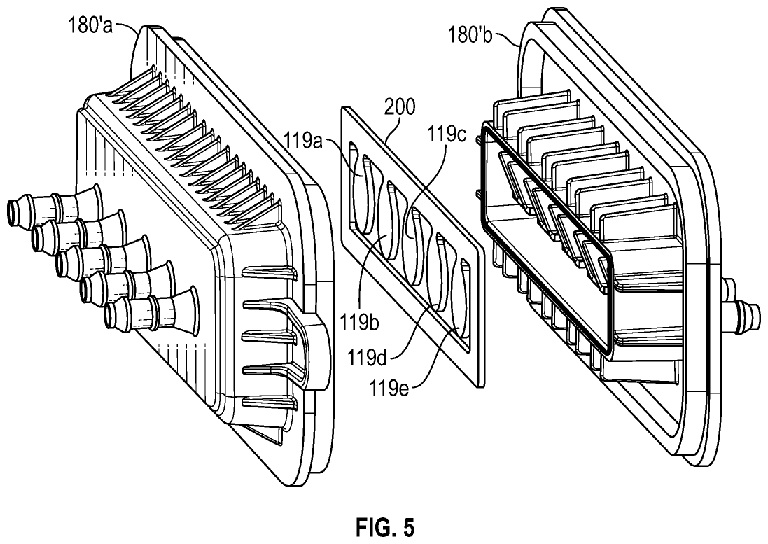

FIGS. 5, 6, 7, 8, 9, and 10 shows a manifold 180 comprising the check valve C therein. As stated above, the at least one check valve C-1, C-2, . . . , C-N is arranged within the manifold 180, wherein the check vale C-1, C-2, . . . , C-N attached to the manifold 180, or alternatively (not shown), is an integral part of thereof. In particular, the first manifold chamber comprises a housing that includes, in turn, an inner surface configured to receive at least a portion of the check valve C-1, C-2, . . . , C-N such that, in use, the first manifold chamber and the check-valve C-1, C-2, . . . , C-N are attached to each other.

FIGS. 5, 6, 7, 8, 9, 10, and 11 show the check valve C as a check valve assembly 190 comprising a frame 200 and five movable portions 119a, 119b, 119c, 119d, and 119e integrally formed with the frame 200. The frame 200 and five movable portions are formed from a resilient or flexible material such as rubber, silicone, plastic, and combinations thereof. In use, the frame 200 is attached to the inner surface of the inlet housing part 180a. In particular, the check valve C comprises a flexible membrane. Further, each movable portion 119a-119e is a deformable portion.

The check valve C is configured to have an open position and a closed position. As shown in FIG. 6, the close position prevents backflow towards the one or more pumps 130-1, 130-2, 130-3, . . . , 130-N. Particularly when the manifold 181 has two or more inlets manifold.

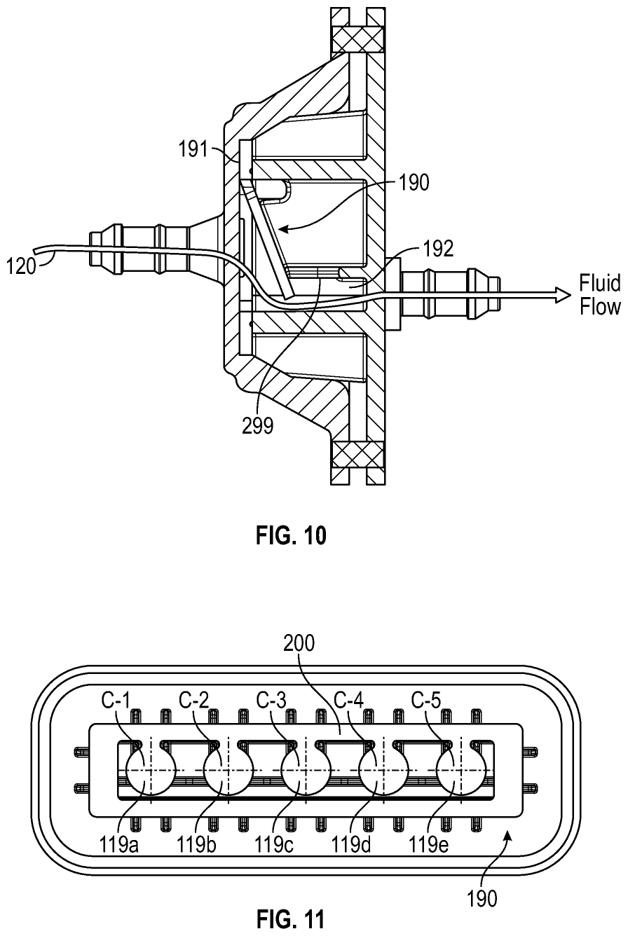

As shown in FIGS. 8 and 10, in the open position, the fluid 120 in the first manifold chamber causes one or more of the movable portions 119a-119e to turn on an axis such that the first manifold chamber is configured to distribute the fluid 120 towards at least one fluid dispenser 140-1, 140-2, 140-3, . . . , 140-M. That is, fluid pressure causes the one or more deformable portions 119a-119e to turn on an axis when the fluid 120 flows through.

FIG. 10 shows the manifold housing comprising a second inner surface or travel limiter 299 configured to abut the check valve C in the open position to restrict the movement of the deformable portion. In the open position, the deformable portion of the check valve C has an angle of between 5°-60° with respect to the closed position. Particularly, an angle of between 10°-45°. More particularly, an angle of between 15°-30°. Travel limiter 299 establishes a selected dwell or response time for check valve C.

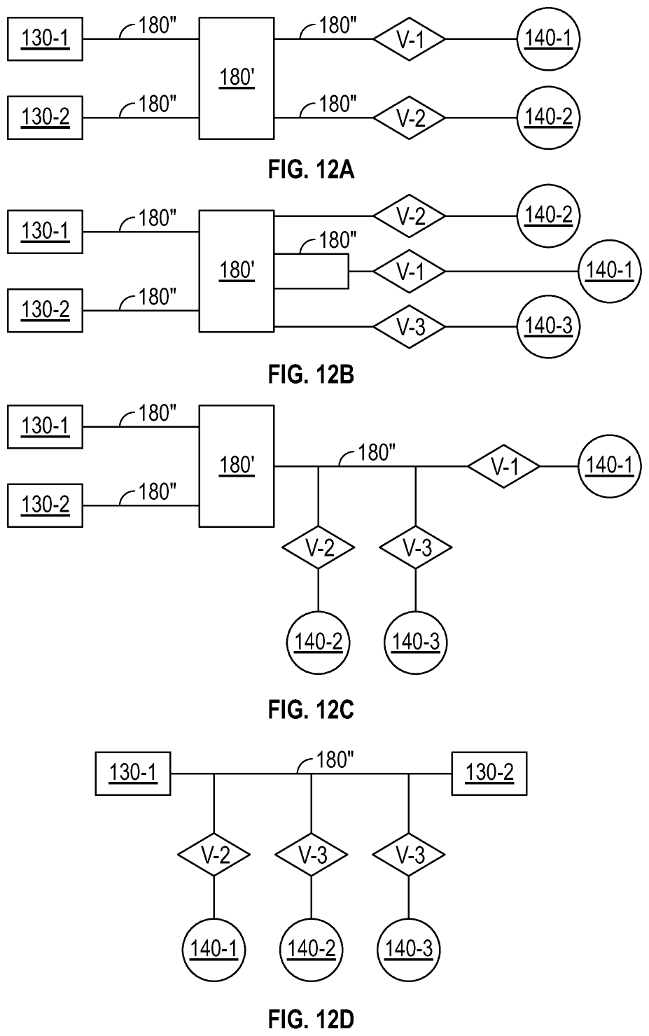

FIGS. 12A, 12B, 12C, and 12D shows different geometries and/or architectures that may be implemented as the manifold 180. As stated above, the minimum requirement of the manifold 180 is to be provided with one or more inlet manifold and two or more outlets manifold. In the shown example, FIG. 12A shows a first fluid inlet, a second fluid inlet, a first fluid outlet and a second fluid outlet. The first fluid inlet is fluidly connected to a first pump 130-1 and the second fluid inlet is fluidly connected to a second pump 130-2. The first fluid outlet is fluidly connected to a first control valve V-1 and the second fluid outlet is fluidly connected to a second control valve V-2. It should be noted that the manifold 180 comprises the first manifold chamber and the pipes fluidly connected to the first pump 130-1, the second pump 130-2, the first control valve V-1, and the second control valve V-2. Thus, the control valves V-1, V-2 are not part of the manifold 180.

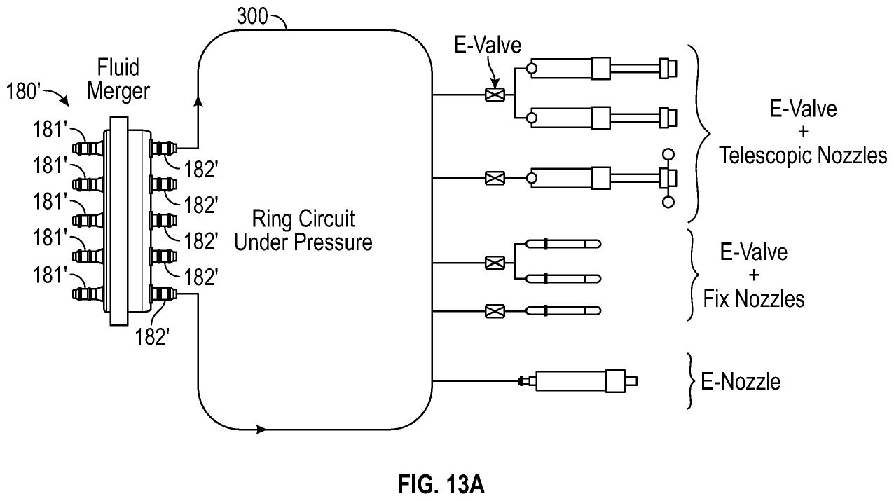

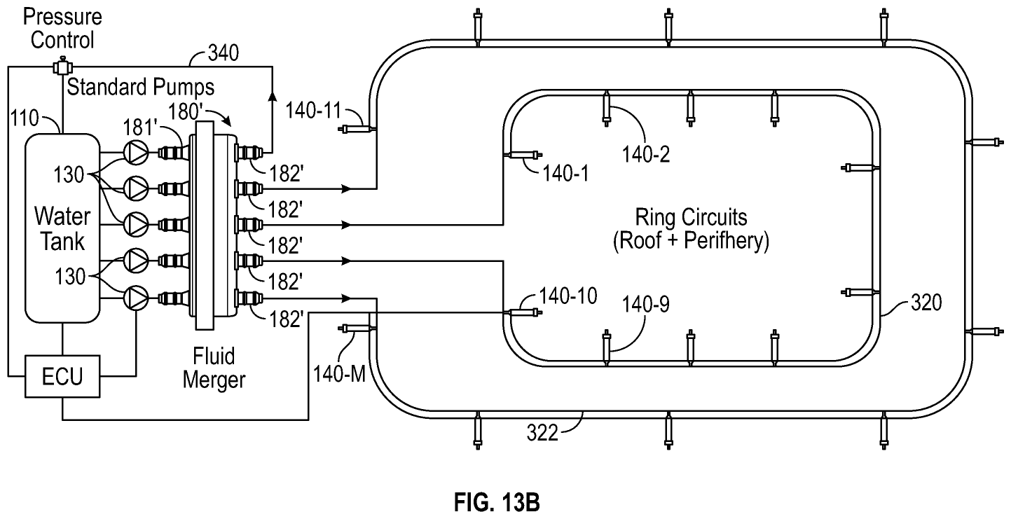

FIG. 12B and FIGS. 13A and 13B illustrate the first fluid outlet is fluidly connected to the second fluid outlet. It forms a ring circuit 300 or the like, wherein the fluid 120 is gathered from the pumps 130-1, 130-2 and passed into ring circuit 300 via manifold 180′. Ring circuit 300 is fluidically connected between two of the plurality of outlets 182 of manifold 180. Fluid 120 enters into ring circuit 300 and is distributed through one or more fluid dispensers or nozzles 140 towards the target objects 150-1-150-0 (FIG. 1). In particular, as shown in FIG. 13A, ring circuit 300 includes two fluid inlets which are the outlets 181 of the first manifold chamber.

In a non-limiting example, manifold 180′ may be connected to a first ring circuit 320 and a second ring circuit 322. First ring circuit 320 is connected to two of the plurality of outlets 182 of manifold 180 and second ring circuit 322 is connected to another two of the plurality of outlets 182. First ring circuit 320 is connected to a first number of the plurality of nozzles 140 and second ring circuit 322 is connected to a second number of the plurality of nozzles 140. Fluid 120 enters first ring circuit 320 and/or second ring circuit 322 and is distributed through corresponding ones of the first number of the plurality of nozzles 140 and the second number of the plurality of nozzles 140 towards the target objects 150-1-150-0 (FIG. 1). In the non-limiting example shown in FIG. 13B a return circuit 340 guides excess fluid from manifold 180 back to water tank 110.

The third illustration of FIG. 12C illustrates the first manifold chamber provided with at least two inlets and one outlet. Fluid 120 from said outlet, in turn, is distributed to three outlets associated with control valves V-1, V-2, V-3. The manifold 180 comprises the first manifold chamber but also the pipes fluidly connecting the pumps 130-1, 130-2 to the first manifold chamber and/or the ducts fluidly connecting the first manifold chamber to the control valves V-1, V-2, V-3.

The fourth illustration of FIG. 12D illustrates a piping 180 connected to pumps 130-1, 130-2. The piping is the manifold 180. The piping comprises three ducts each associated to control valves V-1, V-2, V-3.

In short, as illustrated in FIG. 12A-12D, the present manifold 180 comprises the first manifold chamber (that may be a piping) and optionally one or more pipes fluidly connected to the one or more outlets of the first manifold chamber. It is preferred that the fluid pressure in the first manifold chamber and in the one or more pipes are substantially the same or similar, e.g. a pressure variation of less than 10%.

1. A fluid dispensing system for a vehicle comprising:
one or more pumps, each of the one or more pumps including an inlet connected to a source of fluid and an outlet;
a plurality of fluid dispensers, each of the plurality of fluid dispensers being fluidically connected to the one or more pumps, the plurality of fluid dispensers being configured to direct a stream of fluid towards a target surface;
a control circuit operatively connected to each of the one or more pumps, the control circuit being configured to activate the one or more pumps to wash at least one target surface;
a manifold including one or more fluid inlets connected to each of the one or more pumps and a plurality of fluid outlets each connected to one or more of the plurality of fluid dispensers; and
at least one check valve configured to prevent backflow from the manifold to at least one or more pumps, the at least one check valve being one of a first position arranged at the outlet of the corresponding one or more pumps and at a second position arranged between the one or more pumps and the manifold and at a third position integrated into the manifold.

2. The fluid dispensing system according to claim 1, wherein the manifold includes a manifold chamber defined between the one or more fluid inlets and the plurality of fluid outlets, the at least one check valve being arranged in the manifold chamber.

3. The fluid dispensing system according to claim 2, wherein the at least one check valve includes a check valve assembly including a frame, at least one movable portion being pivotally connected to the frame.

4. The fluid dispensing system according to claim 3, wherein the manifold includes a housing having an inlet housing part supporting one or more fluid inlets and an outlet housing part supporting the plurality of fluid outlets, the frame being mounted between the inlet housing part and the outlet housing part.

5. The fluid dispensing system according to claim 4, wherein the outlet housing part includes an inner surface defining a travel limiter, the at least one movable portion, in use, is adapted for abutting the travel limiter when moving from a closed position to an open position.

6. The fluid dispensing system according to claim 5, wherein it further includes a plurality of pumps, wherein the manifold includes a plurality of fluid inlets, and wherein the at least one check valve includes a plurality of movable portions.

7. The fluid dispensing system according to claim 6, wherein each of the plurality of movable portions is integrally formed with the frame.

8. The fluid dispensing system according to claim 7, wherein the check valve assembly is formed from a resilient material.

9. The fluid dispensing system according to claim 1, further comprising a ring circuit connected between at least two of the plurality of fluid outlets, the ring circuit supporting one or more of the plurality of fluid dispensers, wherein the manifold is a one-single device.

10. The fluid dispensing system according to claim 1, wherein the control circuit is configured to receive or determine required fluid demands of the target surface to be delivered towards the target surface, and wherein the control circuit is configured to operate which pump or pumps has/have to be operated depending on the fluid demands.

11. The fluid dispensing system according to claim 1, wherein it further comprises at least one control valve configured to be actuated by the control circuit, wherein the at least one control valve is arranged between the manifold and at least one of the plurality of fluid dispensers, including in the manifold or in the at least one of the plurality of fluid dispensers.

12. The fluid dispensing system according to claim 11, wherein at least one of the plurality of fluid dispensers is a telescopic fluid dispenser being capable of extending from a rest position to an extended position and retracting from the extended position to the rest position, wherein the at least one control valve comprises a fluid inlet for receiving fluid from the source of fluid, a first fluid outlet for discharging fluid into the telescopic fluid dispenser, and a second fluid outlet for allowing fluid to flow back away from the telescopic fluid dispenser when retracting from the extended position to the rest position.

13. The fluid dispensing system according to claim 1, wherein one of the plurality of fluid outlets defines a fluid return path configured to carry excess fluid from the manifold back to the source of fluid.

14. A manifold for a vehicle fluid dispensing system comprising:
a housing having one or more fluid inlets and a plurality of fluid outlets; and
at least one check valve configured to prevent backflow, the at least one check valve being integrated into the manifold between the corresponding one or more inlets and the plurality of fluid outlets, wherein the housing includes a manifold chamber defined between the one or more fluid inlets and the plurality of fluid outlets, the at least one check valve being arranged in the manifold chamber.

15. The manifold according to claim 14, wherein the at least one check valve includes a check valve assembly including a frame, and at least one movable portion being pivotally connected to the frame.

16. The manifold according to claim 15, wherein the at least one movable portion is integrally formed with the frame.

17. The manifold according to claim 16, wherein it further comprises a plurality of fluid inlets, wherein the at least one check valve includes a plurality of movable portions arranged in the manifold chamber, and wherein each movable portion is associated to each fluid inlet.

18. The manifold according to claim 15, wherein the manifold includes a housing having an inlet housing part supporting the one or more fluid inlets and an outlet housing part supporting the plurality of fluid outlets, the frame being mounted between the inlet housing part and the outlet housing part.

19. The manifold according to claim 18, wherein the outlet housing part includes an inner surface defining a travel limiter, the at least one movable portion, in use, is adapted for abutting the travel limiter when moving from a closed position to an open position.

20. The manifold according to claim 14, further comprising a ring circuit connected between at least two of the plurality of fluid outlets, the ring circuit being fluidly connected to one or more of a plurality of fluid dispensers, wherein the manifold is a one-single device.
